(19) United States
(12) Patent Application Publication
(10) Pub. No.: US 2025/0234194 A1
(43) Pub. Date: Jul. 17, 2025

(54) METHOD AND APPARATUS TO RETRIEVE AERIAL SUBSCRIPTION INFORMATION

(71) Applicant: Lenovo (Singapore) Pte. Ltd., New Tech Park (SG)

(72) Inventor: Roozbeh Atarius, La Jolla, CA (US)

(21) Appl. No.: 18/849,385

(22) PCT Filed: Mar. 23, 2023
(86) PCT No.: PCT/IB2023/052892

§ 371 Date: Sep. 20, 2024

Related U.S. Application Data
(60) Provisional application No. 63/323,025, filed on Mar. 23, 2022.

(51) Int. Cl. H04W 12/06; H04W 8/20; H04W 12/73; H04W 76/20; H04W 84/06

(52) U.S. Cl. CPC H04W 12/06; H04W 8/20; H04W 12/73; H04W 76/20; H04W 84/06

(57) ABSTRACT

Apparatuses, methods, and systems are disclosed for distributing aerial subscription information. One method includes receiving, from a first network entity, a first request message for a service authorization and authentication (“AA”) procedure, and receiving, from a second network entity, aerial subscription information corresponding to an Uncrewed Aerial Vehicle (“UAV”) associated with the first request message. The method includes transmitting, to a third network entity, a second request message for the service AA procedure, and receiving, from the third network entity, a first response message indicating a result of the service AA procedure. The method includes transmitting a third request message comprising the aerial subscription information and the result of the service AA procedure.

### CROSS-REFERENCE TO RELATED APPLICATIONS

This application claims priority to U.S. Provisional Patent Application No. 63/323,025 entitled “METHOD AND APPARATUS TO INFORM RADIO ACCESS NETWORK OF UAV AERIAL SUBSCRIPTION INFORMATION” and filed on 23 Mar. 2022 for Roozbeh Atarius, which application is incorporated herein by reference.

### FIELD

The subject matter disclosed herein relates generally to wireless communications and more particularly relates to retrieving and distributing aerial subscription information.

### BACKGROUND

A wireless communications system may include one or multiple network communication devices, such as base stations, which may be otherwise known as an evolved NodeB (“eNB”), a next-generation NodeB (“gNB”), or other suitable terminology. Each network communication devices, such as a base station may support wireless communications for one or multiple user communication devices, which may be otherwise known as user equipment (“UE”), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (“3G”) Radio Access Technology (“RAT”), fourth generation (“4G”) RAT, fifth generation (“5G”) RAT, among other suitable RATs beyond 5G (e.g., sixth generation (“6G”)).

The wireless communication system may also support Uncrewed aerial system Service Supplier (“USS”) Uncrewed Aerial Vehicle (“UAV”) Authorization/Authentication (“UUAA”), to be carried out by, for example, a Third Generation Partnership Project (“3GPP”) network when a UAV registers with the 3GPP network or when the UAV transmits a request to establish a data connection (e.g., a Packet Data Unit (“PDU”) Session or Packet Data Network (“PDN”) Connection) with the 3GPP network. For the UAV to request resources for UAV operation from the 3GPP network requires the UAV to have a prior flight authorization from an Uncrewed aerial system Traffic Management (“UTM”) system.

### BRIEF SUMMARY

Disclosed are solutions for distributing aerial subscription information. Said solutions may be implemented by apparatus, systems, methods, and/or computer program products.

One method at a Mobility Management Entity (“MME”) includes receiving, from a first network entity, a first request message for a service authorization and authentication (“AA”) procedure, and receiving, from a second network entity, aerial subscription information corresponding to a UAV associated with the first request message. The method includes transmitting, to a third network entity, a second request message for the service AA procedure, and receiving, from the third network entity, a first response message indicating a result of the service AA procedure. The method includes transmitting a third request message comprising the aerial subscription information and the result of the service AA procedure.

One method at a Radio Access Network (“RAN”) includes receiving, from a UAV, a first request message for a service AA procedure, and transmitting, to a first network entity, a second request message for the service AA procedure. The method includes receiving, from the first network entity, a first response message comprising aerial subscription information corresponding to the UAV and a result of the service AA procedure, and transmitting, to the UAV, a third request message to reconfigure a radio connection.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1A illustrates an example of a wireless communication system for informing a RAN of Aerial UE subscription information;

FIG. 1B illustrates an example of a network architecture for interworking between the 5G System (“5GS”) and the Evolved Packet System (“EPS”);

FIG. 2 illustrates an example of a New Radio (“NR”) protocol stack;

FIG. 3 illustrates an example of a procedure for UUAA and Command and Control (“C2”) authorization at PDN connection establishment when attaching to EPS;

FIG. 4 illustrates an example of a procedure for UUAA in the context of the Registration procedure;

FIG. 5 illustrates an example of a procedure for UUAA and C2 authorization at PDN connection establishment when a UE is already registered to EPS;

FIG. 6 illustrates an example of a procedure for retrieving a UE context;

FIG. 7 illustrates an example of a user equipment apparatus that may be used for informing a RAN of Aerial UE subscription information;

FIG. 8 illustrates an example of a network apparatus that may be used for informing a RAN of Aerial UE subscription information;

FIG. 9 illustrates a flowchart diagram of a first method for distributing aerial subscription information; and

FIG. 10 illustrates a flowchart of a second method for distributing aerial subscription information.

### DETAILED DESCRIPTION

The present disclosure describes systems, methods, and apparatus for distributing aerial subscription information, for example, informing a RAN of Aerial UE subscription information. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

For the Uncrewed Aerial System (“UAS”) services in 5GS, the UUAA can be performed at registration (referred to as “UUAA-MM”) or at PDU session establishment (referred to as “UUAA-SM”). In some embodiments, the UUAA may always be performed in EPS at the time of the PDN connection establishment, i.e., UUAA-SM.

At the time of UUAA for the UAS services independent of the EPS and the 5GS, the UE's aerial subscription must be obtained to determine whether the UE is “allowed” or “not-allowed” for the UAS services. The UE's aerial subscription information must also be provided to the RAN at the time of UE's authorization and authentication for the UAS services which may be successful. Since the Access and Mobility Management Function (“AMF”) currently informs the RAN about the UE's subscription information, it is not clear if the UE is registered first as a regular UE and after some times, the UE attempts to get authorization for UAS services by establishing a PDU session or a PDN connectivity, how the AMF or the MME realizes about the UE's registration for UAS services to inform the RAN whether the UE's aerial information allows or disallows for this registration.

In EPS, the UUAA may be done exclusively at the time of the PDN connection establishment. However, if the UE is already attached to EPS with an established PDN connection, the UE needs to establish the PDN connection for UUAA to get access to the UAS services.

Furthermore, during the UAS service operation, the UE may change the RAN from NR to Evolved UTRAN (“E-UTRAN”) or vice versa within 5GS or when changing from the EPS, where the information about the UE being allowed or not allowed for UAS services should be conveyed to the new RAN. It is not clear how to convey this information.

3GPP has defined architecture enhancements for UAVs with the following functionality:
Authentication and authorization of a UAV with the USS during 5GS registration and EPS registration.
Authentication and authorization of a UAV with the USS during PDU session establishment and PDN connection establishment.
Support for USS authorization of C2 Communication in 5GS and EPS.
A reference model for UAV tracking, supporting three UAV tracking modes:
   UAV location reporting mode;
   UAV presence monitoring mode; and
   Unknown UAV tracking mode.

The 3GPP system supports geo-fencing (for in-flight UAV) and geo-caging (for UAV on the ground intending to fly) functionality in USS by providing enablers such as location services, event notification to a subscribing USS, etc.

Note that geo-fencing/geo-caging mechanisms are an air traffic control functionality performed by the USS and are out of scope of the 3GPP. The 3GPP system provides enablers to support geo-fencing/geo-caging functionality in USS, e.g., location services, enablement of C2 connectivity, event notification to a subscribing USS, etc. However, no specific geo-fencing/geo-caging mechanisms are defined in 3GPP.

In addition, the EPS capable for UAV services supports the functionalities for:
subscription-based Aerial UE identification and authorization, e.g., as specified in 3GPP Technical Specification (“TS”) 23.401, clause 4.3.31, where the MME supporting the UAS services, retrieves the aerial UE subscription information from the Home Subscriber Server (“HSS”) by using Aerial-UE-Subscription-Information Attribute-Value Pairs (“AVP”) from Subscription-data AVP, at the time of attach. The aerial subscription information is shared by eNB by the aerial UE subscription information Information Element (“IE”), e.g., as defined in 3GPP TS 36.413. The aerial subscription information can further be passed on from one eNB to another eNB at the time of handover by using the aerial UE subscription information IE, e.g., as defined in 3GPP TS 36.423;
height reporting based on the event that the UE's altitude has crossed a network-configured reference altitude threshold;
interference detection based on a measurement reporting that is triggered when a configured number of cells (i.e., larger than one) fulfils the triggering criteria simultaneously;
signaling of flight path information from UE to E-UTRAN;
location information reporting, including UE's horizontal and vertical velocity; and
open loop power control enhancements including UE specific pathloss compensation factor and extended range of nominal target received power.

Note that the 5GS capable for UAV services, most likely supports the similar functionalities. However, they are not defined yet and these functionalities are most likely defined in future releases such as 3GPP Release 17 (“Rel-17”) or Release 18 (“Rel-18”).

Aspects of the present disclosure are described in the context of a wireless communications system. Aspects of the present disclosure are further illustrated and described with reference to apparatus diagrams and flowcharts.

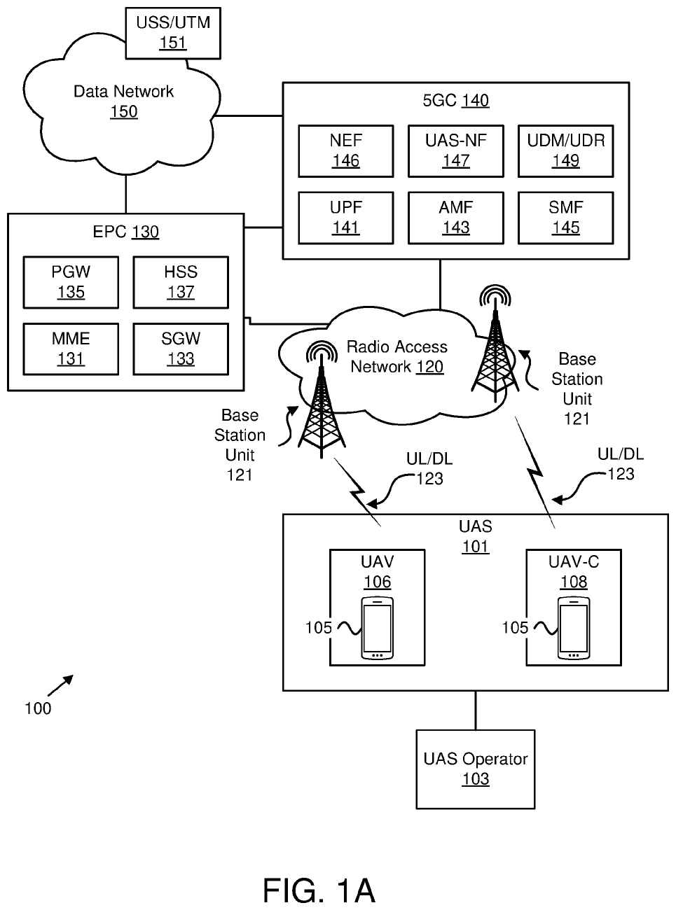

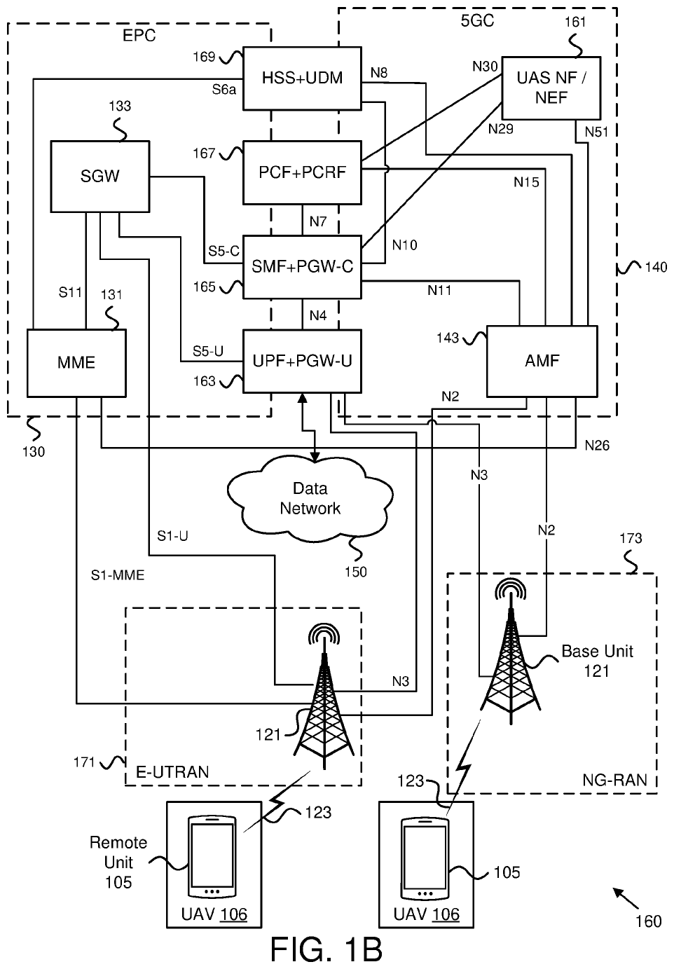

FIG. 1A illustrates an example of a wireless communication system 100 supporting exchanging UAV credentials between a UAV and 3GPP network for UAV authorization, in accordance with aspects of the present disclosure. The wireless communication system 100 includes at least one remote unit 105, at least one UAV 106 (each of which may include an instance of a remote unit 105), at least one UAV Controller (“UAV-C”) 108 (each of which may include an instance of a remote unit 105), a radio access network (“RAN”) 120, an evolved packet core network (“EPC”) 130, and a 5G core network (“5GC”) 140. The RAN 120 and the EPC 130 and/or 5GC 140 form a mobile communication network. The RAN 120, in various embodiments, comprises a base station unit 121 with which the remote unit 105 communicates using wireless communication links 123. The wireless communications system 100 may support various radio access technologies. In some embodiments, the wireless communications system 100 may be a 4G network, such as an Long-Term Evolution (“LTE”) network or an LTE-Advanced (“LTE-A”) network. In some other embodiments, the wireless communications system 100 may be a 5G network, such as an NR network. In other embodiments, the wireless communications system 100 may be a network beyond 5G. Additionally, even though a specific number of remote units 105, base station units 121, wireless communication links 123, RANs 120, and mobile core networks 140 are depicted in FIG. 1A, one of skill in the art will recognize that any quantity of remote units 105, base station units 121, wireless communication links 123, RANs 120, and mobile core networks 140 may be included in the wireless communication system 100.

An UAS 101, in various embodiments, includes a UAV 106, e.g., a “drone,” and a UAV-C 108. The UAS Operator 103 is, for example, the person who operates the UAV 106 (e.g., via the UAV-C 108) and who, typically, issues requests for flight authorizations. The UAV 106 and UAV-C 108 may each be Aerial UEs in the wireless communication system 100 and/or may include an instance of a remote unit 105. As such, the UAV 106 may communicate with a RAN 120 to access services provided by the EPC 130 and/or the 5GC 140.

In some embodiments, the Aerial UEs (i.e., remote units 105) communicate with one or more UAV Traffic Management (“UTM”) functions via a network connection with the EPC 130 and/or the 5GC 140. For example, as described below, the UAV 106 and/or UAV Controller 108 may establish a PDU session (or similar data connection) with the 5GC 140 using the RAN 120. Here, the 5GC 140 is configured to relay traffic between the Aerial UE and the data network 150 using the PDU session.

In one implementation, the RAN 120 is compliant with the 5G cellular system specified in the 3GPP specifications. For example, the RAN 120 may be a Next Generation Radio Access Network (“NG-RAN”), implementing NR RAT and/or LTE RAT. In another example, the RAN 120 may include non-3GPP RAT (e.g., Wi-Fi® or Institute of Electrical and Electronics Engineers (“IEEE”) 802.11-family compliant wireless local area network (“WLAN”)). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

The one or more remote units 102 may be dispersed throughout a geographic region of the wireless communications system 100. A remote unit 102 may include or may be referred to as a UE, a computing device, such as a desktop computer, a laptop computer, a personal digital assistant (“PDA”), a tablet computer, a smart phone, a smart television (e.g., a television connected to the Internet), smart appliance (e.g., an appliance connected to the Internet), a set-top box, a game console, a security system (including one or more security cameras), a vehicle on-board computer, a network device (e.g., router, switch, modem), or the like. In some embodiments, the remote units 105 include wearable devices, such as smart watches, fitness bands, optical head-mounted displays, or the like. Moreover, the remote units 105 may be referred to as subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

In some embodiments, the remote units 105 may communicate directly with other remote units 105 via sidelink (“SL”) communication signals. Furthermore, the SL communication signals may comprise one or more SL channels, such as the Physical Sidelink Control Channel (“PSCCH”), the Physical Sidelink Shared Channel (“PSSCH”), and/or Physical Sidelink Feedback Channel (“PSFCH”).

In some embodiments, the remote units 105 may communicate directly with one or more of the base station units 121 in the RAN 120 via uplink (“UL”) and downlink (“DL”) communication signals. Furthermore, the UL and DL communication signals may be carried over the wireless communication links 123. Furthermore, the UL communication signals may comprise one or more UL channels, such as the Physical Uplink Control Channel (“PUCCH”) and/or Physical Uplink Shared Channel (“PUSCH”), while the DL communication signals may comprise one or more DL channels, such as the Physical Downlink Control Channel (“PDCCH”) and/or Physical Downlink Shared Channel (“PDSCH”). Here, the RAN 120 is an intermediate network that provides the remote units 105 with access to the EPC 130 and/or the 5GC 140.

In some embodiments, the remote units 105 communicate with an application server in the data network 150 via a network connection with the EPC 130 and/or the 5GC 140. For example, an application (e.g., a UAS application) in a remote unit 105 may trigger the remote unit 105 to establish a PDU session (or other data connection) with the 5GC 140 via the RAN 120. The 5GC 140 may then relay traffic between the remote unit 105 and the application server (e.g., a UAS Application-specific server) using the PDU session. The PDU session represents a logical connection between the remote unit 105 and a User Plane Function (“UPF”) 141 in the 5GC 140. As another example, the application may trigger the remote unit 105 to establish a PDN connection (or other data connection) with the EPC 130 via the RAN 120. The EPC 130 may then relay traffic between the remote unit 105 and the application server using the PDU session. The PDN connection represents a logical connection between the remote unit 105 and a PDN gateway (“PGW”) 135 in the EPC 130.

In order to establish the PDU session, the remote unit 105 must be registered with the 5GC 140. Similarly, in order to establish a PDN connection, the remote unit 105 must be attached to the EPC 130. Note that the remote unit 105 may establish one or more PDU sessions or PDN connection (or other data connections) with the EPC 130 and the 5GC 140. As such, the remote unit 105 may concurrently have at least one PDU session (or PDN connection) for communicating with the data network 150 and at least one PDU session (or PDN connection) for communicating with other data networks and/or other communication peers (not shown).

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the EPS, a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a PGW 135 in the EPC 130. In certain embodiments, there is a one-to-one mapping between an EPS Bearer and a QoS profile, such that all packets belonging to a specific EPS Bearer have the same QoS Class Identifier (“QCI”).

The base station units 121 may be distributed and/or positioned over a geographic region. In certain embodiments, a base station unit 121 may also be referred to as an access terminal, an access point, a base, a base station, a base unit, a Node-B (“NB”), an eNB (also referred to as “eNodeB”), a 5G/NR Node B (e.g., gNB), a Home Node-B, a relay node, a RAN node, or by any other terminology used in the art. The base station units 121 are generally part of a RAN, such as the RAN 120, that may include one or more controllers communicably coupled to one or more corresponding base station units 121. These and other elements of radio access network are not illustrated but are well known generally by those having ordinary skill in the art. The base station units 121 connect to the EPC 130 and the 5GC 140 via the RAN 120.

The base station units 121 may serve a number of remote units 105 within a serving area, for example, a cell or a cell sector, via a wireless communication link 123. The base station units 121 may communicate directly with one or more of the remote units 105 via communication signals. Generally, the base station units 121 transmit DL communication signals to serve the remote units 105 in the time, frequency, and/or spatial domain. Furthermore, the DL communication signals may be carried over the wireless communication links 123. The wireless communication links 123 may include any suitable carrier in the licensed or unlicensed radio spectrum. The wireless communication links 123 are configured to facilitate communication between one or more of the remote units 105 and/or one or more of the base station units 121.

Note that during NR operation on unlicensed spectrum (referred to as “NR-U”), the base station unit 121 and the remote unit 105 communicate over unlicensed (i.e., shared) radio spectrum. Similarly, during LTE operation on unlicensed spectrum (referred to as “LTE-U”), the base station unit 121 and the remote unit 105 also communicate over unlicensed (i.e., shared) radio spectrum.

In one embodiment, the EPC 130 and the 5GC 140 are mobile core networks which may be coupled to a data network 150, like the Internet and private data networks, among other data networks. A remote unit 105 may have a subscription or other account with the EPC 130 and the 5GC 140. In certain embodiments, the EPC 130 and the 5GC 140 belong to a single mobile network operator (“MNO”) and/or public land mobile network (“PLMN”). The present disclosure is not intended to be limited to the implementation of any particular wireless communication system architecture or protocol.

The 5GC 140, in some embodiments, includes several network functions (“NFs”). As depicted, the 5GC 140 includes at least one user plane function (“UPF”) 141. The 5GC 140 also includes multiple control plane (“CP”) functions including, but not limited to, an AMF 143 that serves the RAN 120, a Session Management Function (“SMF”) 145, a Network Exposure Function (“NEF”) 146, a UAS Network Function (“UAS NF”) 147, a Unified Data Management function (“UDM”) and a User Data Repository (“UDR”). In some embodiments, the UDM is co-located with the UDR, depicted as combined entity “UDM/UDR” 149. Although specific numbers and types of network functions are depicted in FIG. 1A, one of skill in the art will recognize that any number and type of network functions may be included in the 5GC 140.

The UPF(s) 141 is/are responsible for packet routing and forwarding, packet inspection, QoS handling, and external PDU session for interconnecting Data Network (“DN”), in the 5G architecture. The AMF 143 is responsible for termination of Non-Access Stratum (“NAS”) signaling, NAS ciphering and integrity protection, registration management, connection management, mobility management, access authentication and authorization, security context management.

The SMF 145 is responsible for session management (i.e., session establishment, modification, release), remote unit (i.e., UE) Internet Protocol (“IP”) address allocation and management, DL data notification, and traffic steering configuration of the UPF 141 for proper traffic routing. The RAN 120 configures the remote unit 105 using radio resource control (“RRC”) protocol over the Uu interface (e.g., LTE-Uu and/or NR-Uu). The NEF 146 is responsible for making network data and resources easily accessible to customers and network partners.

The UDM is responsible for generation of Authentication and Key Agreement (“AKA”) credentials, user identification handling, access authorization, subscription management. The UDR is a repository of subscriber information and can be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 149.

To support UAS operation and related security aspects, the 5GC 140 may also include a UAS NF 147 for interacting with a UAS Service Supplier (“USS”) system and/or a UAS Traffic Management (“UTM”) system (depicted as combined node “USS/UTM” 151). The USS/UTM 151, in one embodiment, provides a set of overlapping USSs that assist UAS operators 103 in conducting safe and compliant operations. The services may include deconfliction of flight plans, remote identification, and/or the like. In another embodiment, the USS/UTM 151 may be used to associate (i.e., pair) a UAV 106 with a UAV-C 108. Here, each UAV 106 provides its identity to the USS/UTM 151 and the USS/UTM 151 authorizes the request. The USS/UTM 151 may be located outside the mobile core network and may interact with core network function, such as the UAS NF 147, via the NEF 146.

While depicted as a standalone network function, in an alternative deployment of the system 100, the UAS NF 147 may be implemented as a service offered by NEF 146. The UAS NF 147 is supported by the NEF 146 (or by both an NEF and Service Capability Exposure Function (“SCEF”)—denoted “NEF/SCEF”) and is used for external exposure of services to the USS. In some embodiments, the UAS NF 147 uses existing NEF/SCEF exposure services for UAV authentication/authorization, for UAV flight authorization, for UAV/UAV-C pairing authorization, and related revocation; for location reporting, and control of QoS/traffic filtering for C2 communication.

In various embodiments, the 5GC 140 may also include a Network Repository Function (“NRF”) (which provides Network Function (“NF”) service registration and discovery, enabling NFs to identify appropriate services in one another and communicate with each other over Application Programming Interfaces (“APIs”)), a Policy Control Function (“PCF”) (e.g., responsible for unified policy framework, providing policy rules to CP functions, access subscription information for policy decisions in UDR), an Authentication Server Function (“AUSF”), or other NFs defined for the 5GC. When present, the AUSF may act as an authentication server and/or authentication proxy, thereby allowing the AMF 143 to authenticate a remote unit 105. In certain embodiments, the 5GC 140 may include an authentication, authorization, and accounting (“AAA”) server.

In various embodiments, the 5GC 140 supports different types of mobile data connections and different types of network slices, wherein each mobile data connection utilizes a specific network slice. Here, a “network slice” refers to a portion of the 5GC 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network instance may be identified by a single-network slice selection assistance information (“S-NSSAI”), while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1A for ease of illustration, but their support is assumed.

The EPC 130, in some embodiments, includes several network entities. As depicted, the EPC 130 includes at least one Mobility Management Entity (“MME”) 131, at least one Serving Gateway (“SGW”) 133, at least one PGW 135, and at least one HSS 137. In some embodiments, the EPC 130 may also include an Authentication Center (“AuC”), an AAA server, or other EPC entities known in the art. Although specific numbers and types of network functions are depicted in FIG. 1A, one of skill in the art will recognize that any number and type of network functions may be included in the EPC 130.

In various embodiments, the MME 131 is responsible for termination of NAS signaling, NAS ciphering and integrity protection, registration management, paging, connection management, mobility management, access authentication and authorization, security key management. In some embodiments, the SGW 133 and a user plane portion of the PGW 135 (referred to as “PGW-U”) is/are responsible for packet routing and forwarding, packet inspection, QoS handling, and external PDN connections for interconnecting DNs in the EPS architecture. In some embodiments, a control plane portion of the PGW 135 (referred to as “PGW-C”) is responsible for session management, IP address allocation and management, DL data notification, and traffic routing configuration in the EPS architecture. In some embodiments, the Home Subscriber Server (“HSS”) is a central database that contains user-related and subscription-related information, to support mobility management, call and session establishment support, user authentication and access authorization.

While FIG. 1A depicts components of an EPC 130 and a 5GC 140, the described embodiments apply to other types of communication networks and RATs, including IEEE 802.11 variants, Global System for Mobile Communications (“GSM”) (i.e., a 2G digital cellular network), General Packet Radio Service (“GPRS”), Universal Mobile Telecommunications System (“UMTS”), LTE variants, CDMA2000, Bluetooth, ZigBee, Sigfox, and the like.

In the following descriptions, the term “gNB” is used for the base station but it is replaceable by any other radio access node, e.g., RAN node, eNB, Base Station (“BS”), next-generation eNB (“ng-eNB”), gNB, Access Point (“AP”), etc. Additionally, the term “UE” is used for the mobile station/remote unit, but it is replaceable by any other remote device, e.g., remote unit, MS, ME, etc. Further the operations are described mainly in the context of 5G NR. However, the proposed solutions/methods are also equally applicable to other mobile communication systems supporting UAS.

FIG. 1B is a block diagram illustrating one embodiment of a network architecture 160 for interworking between the 5GS (i.e., 5GC 140 and/or NG-RAN 173) and the EPS (i.e., EPC 130 and/or E-UTRAN 171). The network architecture 160 shows a variant of the wireless communication system 100 and comprises an embodiment of the RAN 120, an embodiment of the EPC 130, and an embodiment of the 5GC 140. Here, the RAN 120 comprises a E-UTRAN 171 with at least one 4G/LTE base station unit 121 (e.g., an eNB) and a NG-RAN 173 with at least one 5G/NR base station unit 121 (e.g., a gNB).

As depicted, the network architecture includes both 4G core network (i.e., EPC) entities and 5GC entities, and various interworking network functions for to support interworking between the user plane and certain control plane functions in the EPC 130 and the 5GC 140.

The 5GC 140 includes an AMF 143 and a UAS NF and/or NEF (depicted as combined entity UAS NF/NEF 161) that are not shared with the EPC 130. Similarly, the EPC 130 includes an MME 131 and a SGW 133 that are not shared with the 5GC 140. However, there are several shared/combined network entities that support interworking between the EPC 130 and the 5GC 140, including a combined UPF and PGW-user-plane entity (“UPF+PGW-U”) 163, a combined SMF and PGW-control-plane entity (“SMF+PGW-C”) 165, a combined PCF and Policy and Charging Rules Function (“PCRF”) entity (“PCF+PCRF”) 167, and a combined HSS and UDM entity (“HSS+UDM”) 169. Note that the notions “SMF+PGW-C” and “UPF+PGW-U” are used to show that the network functions used for, e.g., PDU Sessions in 5GC 140 and PDN Connections in EPC 130 are common, in case that IP session continuity is required during transfer of PDU Sessions to PDN Connections and vice-versa. Although specific numbers and types of network functions are depicted in FIG. 1B, one of skill in the art will recognize that any number and type of network functions may be included in the mobile core network.

FIG. 1B illustrates an example of various network interfaces that facilitate communication among the core network (“CN”) elements. For example, a base station unit 121 (or RAN node) may communicate with the AMF 143 via the N2 interface and with the UPF+PGW-U 163 via the N3 interface. As another example, a base station unit 121 may communicate with the MME 131 via the S1-MME interface and with the SGW 133 via the S1-U interface. Other network interfaces are depicted, including, but not limited to, a N4 interface between the UPF+PGW-U 163 and the SMF+PGW-C 165, a N7 interface between the SMF+PGW-C 165 and the PCF+PCRF 167, a N8 interface between the AMF 143 and the HSS+UDM 169, a N10 interface between the SMF+PGW-C 165 and the HSS+UDM 169, a N11 interface between the AMF 143 and the SMF+PGW-C 165, a N15 interface between the AMF 143 and the PCF+PCRF 167, a N26 interface between the AMF 143 and the MME 131 (e.g., supporting inter-system handover from the 5GC 140 to EPC 130, or vice versa), a N29 interface between the UAS NF/NEF 161 and the SMF+PGW-C 165, a N30 interface between the UAS NF/NEF 161 and the PCF+PCRF 167, a N51 interface between the UAS NF/NEF 161 and the AMF 143, a S5-U interface between the SGW 133 and the UPF+PGW-U 163, a S5-C interface between the SGW 133 and the SMF+PGW-C 165, a S6a interface between the MME 131 and the HSS+UDM 169, and the S11 interface between the MME 131 and the SGW 133. Although not depicted, the wireless communication system 100 and network architecture 160 support a N1 interface between the remote unit 105 and the AMF 143.

The UAV 106 uses 3GPP access (i.e., E-UTRAN 171 and/or NG-RAN 173) for 3GPP UAV related operations. In some embodiments, the SMF+PGW-C 165 implements the functions defined in 3GPP TS 23.501. For example, the SMF+PGW-C 165 functionality may include:
triggering the UUAA-SM procedure for a UE (i.e., remote unit 105) requiring UAV Authentication and Authorization by a USS when requesting user plane resources for UAV operation, or when the USS/UTM that authenticated the UAV triggers a re-authentication; and
triggering the authorization of pairing between a UAV 106 and a networked UAV-C 108 or a UAV-C 108 that connects to the UAV 106 via internet connectivity during the establishment of a PDN connection and/or PDU session for C2 communication.

The UAS NF/NEF 161 is in direct communication with PCF+PCRF 167, SMF+PGW-C 165 and AMF 143. However, the UAS NF/NEF 161 is not in direct communication with the MME 131. The MME 131, the AMF 143, and the SMF+PGW-C 165 have access to the HSS+UDM 169 which can access the UE's aerial subscription information from the HSS 137 via the UDM.

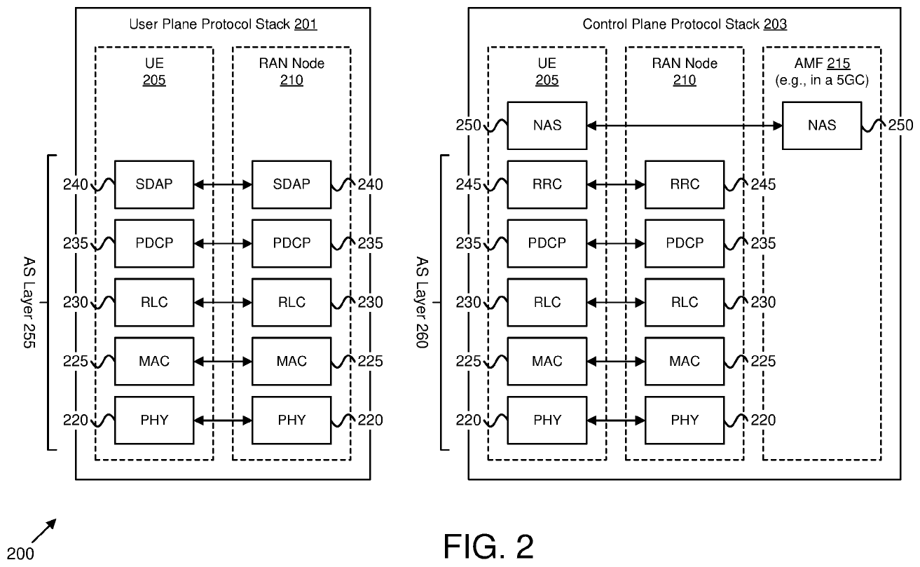

FIG. 2 illustrates an example of an NR protocol stack 200, in accordance with aspects of the present disclosure. While FIG. 2 shows the UE 205, the RAN node 210 and an AMF 215, e.g., in a 5GC, these are representatives of a set of remote units 105 interacting with a base station unit 121 and a mobile core network 140. As depicted, the NR protocol stack 200 comprises a User Plane protocol stack 201 and a Control Plane protocol stack 203. The User Plane protocol stack 201 includes a physical (“PHY”) layer 220, a Medium Access Control (“MAC”) sublayer 225, the Radio Link Control (“RLC”) sublayer 230, a Packet Data Convergence Protocol (“PDCP”) sublayer 235, and Service Data Adaptation Protocol (“SDAP”) sublayer 240. The Control Plane protocol stack 203 includes a PHY layer 220, a MAC sublayer 225, an RLC sublayer 230, and a PDCP sublayer 235. The Control Plane protocol stack 203 also includes an RRC layer 245 and a NAS layer 250.

The Access Stratum (“AS”) layer 255 (also referred to as “AS protocol stack”) for the User Plane protocol stack 201 consists of at least SDAP, PDCP, RLC and MAC sublayers, and the physical layer. The AS layer 260 for the Control Plane protocol stack 203 consists of at least RRC, PDCP, RLC and MAC sublayers, and the physical layer. The Layer-1 (“L1”) consists of the PHY layer 220. The Layer-2 (“L2”) is split into the SDAP sublayer 240, PDCP sublayer 235, RLC sublayer 230, and MAC sublayer 225. The Layer-3 (“L3”) includes the RRC layer 245 and the NAS layer 250 for the control plane and includes, e.g., an IP layer and/or PDU Layer (not shown in FIG. 2) for the user plane. L1 and L2 are referred to as “lower layers,” while L3 and above (e.g., transport layer, application layer) are referred to as “higher layers” or “upper layers.”

The PHY layer 220 offers transport channels to the MAC sublayer 225. The PHY layer 220 may perform a Clear Channel Assessment (“CCA”) and/or Listen-Before-Talk (“LBT”) procedure using energy detection thresholds. In certain embodiments, the PHY layer 220 may send an indication of beam failure to a MAC entity at the MAC sublayer 225. In certain embodiments, the PHY layer 220 may send a notification of Listen-Before-Talk (“LBT”) failure to a MAC entity at the MAC sublayer 235. The MAC sublayer 225 offers logical channels to the RLC sublayer 230. The RLC sublayer 230 offers RLC channels to the PDCP sublayer 235. The PDCP sublayer 235 offers radio bearers to the SDAP sublayer 240 and/or RRC layer 245. The SDAP sublayer 240 offers QoS flows to the core network (e.g., 5GC). The RRC layer 245 provides functions for the addition, modification, and release of Carrier Aggregation and/or Dual Connectivity. The RRC layer 245 also manages the establishment, configuration, maintenance, and release of Signaling Radio Bearers (“SRBs”) and Data Radio Bearers (“DRBs”).

The NAS layer 250 is between the UE 205 and an AMF 215 in the 5GC. NAS messages are passed transparently through the RAN. The NAS layer 250 is used to manage the establishment of communication sessions and for maintaining continuous communications with the UE 205 as it moves between different cells of the RAN. In contrast, the AS layers 255 and 260 are between the UE 205 and the RAN (i.e., RAN node 210) and carry information over the wireless portion of the network. While not depicted in FIG. 2, the IP layer exists above the NAS layer 250, a transport layer exists above the IP layer, and an application layer exists above the transport layer.

The MAC sublayer 225 is the lowest sublayer in the L2 architecture of the NR protocol stack. Its connection to the PHY layer 220 below is through transport channels, and the connection to the RLC sublayer 230 above is through logical channels. The MAC sublayer 225 therefore performs multiplexing and demultiplexing between logical channels and transport channels: the MAC sublayer 225 in the transmitting side constructs MAC PDUs (also known as transport blocks (“TBs”)) from MAC Service Data Units (“SDUs”) received through logical channels, and the MAC sublayer 225 in the receiving side recovers MAC SDUs from MAC PDUs received through transport channels.

The MAC sublayer 225 provides a data transfer service for the RLC sublayer 230 through logical channels, which are either control logical channels which carry control data (e.g., RRC signaling) or traffic logical channels which carry user plane data. On the other hand, the data from the MAC sublayer 225 is exchanged with the PHY layer 220 through transport channels, which are classified as UL or DL. Data is multiplexed into transport channels depending on how it is transmitted over the air.

The PHY layer 220 is responsible for the actual transmission of data and control information via the air interface, i.e., the PHY layer 220 carries all information from the MAC transport channels over the air interface on the transmission side. Some of the important functions performed by the PHY layer 220 include coding and modulation, link adaptation (e.g., Adaptive Modulation and Coding (“AMC”)), power control, cell search and random access (for initial synchronization and handover purposes) and other measurements (inside the 3GPP system (i.e., NR and/or LTE system) and between systems) for the RRC layer 245. The PHY layer 220 performs transmissions based on transmission parameters, such as the modulation scheme, the coding rate (i.e., the modulation and coding scheme (“MCS”)), the number of Physical Resource Blocks (“PRBs”), etc.

Note that an LTE protocol stack comprises similar structure to the NR protocol stack 200, with the differences that the LTE protocol stack lacks the SDAP sublayer 240 in the AS layer 255 and that the NAS layer 250 is between the UE 205 and an MME 131 in the EPC 130.

The UUAA can be performed for a UAV in the 4G EPS. If the UUAA is performed for a UAV during the registration, then an attach request comprising a Packet Data Network (“PDN”) connectivity request message is used for this purpose. Otherwise, the PDN connectivity request can directly be used. The Mobility Management Entity (“MME”) needs to identify the PDN connectivity request for the UUAA, so the MME can fetch the UE's aerial subscription information from the Home Subscriber Server (“HSS”) to share with RAN.

The only point of contact between RAN and CN is the MME. According to the UAS work item, there is no interaction between the MME and the UAS NF and/or NEF. Therefore, the present disclosure provides a mechanism describing how the MME recognizes that the PDN connection is for the UUAA purposes and when it needs to inform the RAN or eNodeB about the UE's aerial subscription information which is “allowed” or “not allowed.” There is a need for such information at the time of:
attach procedure, since the UE may attach to the EPS and establish PDN connection for the UUAA; and/or
establishing a bearer (e.g., default bearer) since the UE may have already been registered to the EPS without any active/default bearer (being in EEM_IDLE mode).

The present disclosure also provides a mechanism describing how, at the time of handover from 5GS to EPS or vice versa, the UE's aerial information may be retrieved directly by the new RAN from the old one.

In some embodiments, a first network entity (e.g., an MME) receives—from a device (e.g., an UAV) 1) a PDN connectivity request message for an UUAA procedure, and 2) an indication the PDN connectivity request message is for the UUAA.

In some embodiments, the first network entity requests an aerial subscription from a second network entity (e.g., an HSS), wherein the aerial subscription belongs to the device.

In some embodiments, the first network entity transmits a create session request message to a third network entity (e.g., a PGW). In such embodiments, the third network entity: A) provides contents of the create session request message to a fourth network entity (e.g., a UAS NF/NEF) to perform the UUAA; and B) obtains a result for the UUAA from the fourth network entity.

In some embodiments, the first network entity receives, from the third network entity, a create session response message comprising the result for the UUAA. In such embodiments, the first network entity may inform a fifth network entity (e.g., an eNodeB) about the result for the UUAA to enable one or more features.

In some embodiments, the first network entity transmits, to the device, an activate EPS bearer context request message comprising the result for the UUAA and receives, from the device, an activate EPS bearer context accept message. In certain embodiments, the activate EPS bearer context request message comprises an activate default EPS bearer context request message and the activate EPS bearer context accept message comprises an activate default EPS bearer context accept message.

In certain embodiments, the PDN connectivity message comprising an extended protocol configuration options (“ePCO”) IE. In various embodiments, the ePCO IE comprises: 1) a container identity; and 2) a Service-level AA container IE comprising: A) a Civil Aviation Authority (“CAA”)-level UAV identity (“ID”) and at least none or more of: i) a USS address; and ii) UUAA aviation payload. In one embodiment, the container identity is the indication the PDN connectivity request message is for the UUAA.

In certain embodiments, the PDN connectivity message comprising an access point name (“APN”), wherein the APN is to establish a bearer (e.g., default bearer) for UAS services. In one embodiment, the APN is the indication the PDN connectivity request message is for the UUAA.

In certain embodiments, the PDN connectivity request message is within an attach request message.

In certain embodiments, the third network entity requesting from the second network entity the aerial subscription in prior to providing the contests of the PDN connectivity request message to the fourth network entity to perform the UUAA.

In certain embodiments, the aerial subscription information comprising a value for: 1) allowed; or 2) not allowed. In such embodiments, the allowed value is the permission of using an UAS service and the not allowed value is the lack of permission of using the UAS service.

In certain embodiments, the one or more features comprising at least: A) an aerial height, wherein the aerial height comprising a lower threshold and an upper threshold; B) an location information, wherein the location information comprising a horizontal velocity and a vertical velocity; C) a flight path information, wherein the flight path information is signaled from an UAV to the fourth network; D) an open loop power control, wherein the open loop power control is used for calculating a pathloss compensation factor; and E) an interference detection, wherein the interference detection is based on UAV reporting measurements to several configured cells, wherein the UAV reporting measurements are triggered by received signal strengths from the several configured cells being above a configured threshold.

In some embodiments, a first radio access network retrieves a device's aerial subscription information from a second radio access network. In certain embodiments, the first radio access network represents a first access technology, and the second radio access network represents a second access technology. In certain embodiments, the device is connected to the first radio access network after losing connection from the second radio access network.

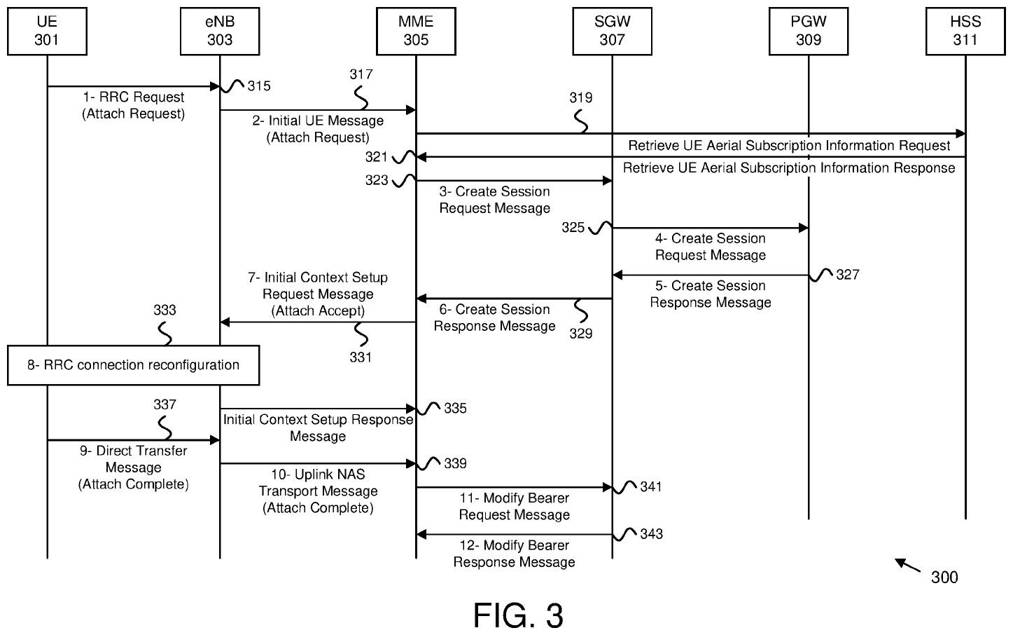

According to embodiments of the first solution, the MME reports to RAN if the UE is allowed or not allowed for the UAS services. As FIG. 1B shows, the UAS NF/NEF is not in direct communication with the MME, therefore the information about the UE's attempt of the network to perform the UUAA may be provided by other means. As it is required for the UE to perform the UUAA for the UAS services, the UE may establish a PDN connection at the time of attach according to FIG. 3.

FIG. 3 depicts an exemplary procedure 300 for UUAA and C2 authorization at PDN connection establishment when attaching to EPS, in accordance with aspects of the present disclosure. The procedure 300 involves the UE 301 (e.g., an embodiment of the UE 205 and/or the remote unit 105), an eNB 303 (e.g., an embodiment of the RAN node 210 and/or base station unit 121), an MME 305 (e.g., an embodiment of the MME 131), an SGW 307 (e.g., an embodiment of the SGW 133), a PGW 309 (e.g., an embodiment of the PGW 135 and/or the SMF+PGW-C 165), and an HSS 311 (e.g., an embodiment of the HSS 137 and/or the HSS+UDM 169).

At Step 1, the UE 301 initiates the attach procedure by sending an RRC request message containing an Attach request (see signaling 315). In various embodiments, the Attach request includes:
the UE network capability IE with the bit set to indicate the support for the ePCO IE; and
a PDN connectivity request message contained in an EPS Session Management (“ESM”) message container IE.

The PDN connectivity request message comprises ePCO IE with the length two octets, e.g., as defined in subclause 10.5.6.3A in 3GPP TS 24.008. The ePCO IE is chosen rather than protocol configuration options (“PCO”) IE with the length one octet as defined in subclause 10.5.6.3 in 3GPP TS 24.008, e.g., due to the amount of the information to be sent being larger than 255 octets, since during that the PDN connectivity and the UUAA, the UE 301 is required to transmit the following information which may comprise:
the CAA-Level UAV ID of the UAV;
the USS address; and
the UUAA aviation payload.

Furthermore, if the UE 301 also considers authorization for C2 communications, then the UE 301 is to additionally transmit the following information which:
the UAS container comprising UAV UAV-C pairing information; and
the flight authorization information.

The UE 301 may use the service-level-AA IE as defined in 3GPP TS 24.501. The ePCO IE has a specific container ID which is specific for the UUAA procedure.

The PDN connectivity request message (i.e., contained in the Attach request) may also comprise a specific APN for the UAS services, in order to indicate the desired PGW 309 to the MME 305. Note that the APN is the name of a gateway between a GSM/GRPS/3G/4G mobile network and another computer network (e.g., the Internet). The APN identifies the PDN that a mobile data user wants to communicate with.

In some embodiments, the UE 301 uses the RRC request message including the Attach request to establish an RRC connection with the eNB 303 (e.g., the E-UTRAN 171 or NG-RAN 173).

At Step 2, upon receipt of the RRC request message by the eNB 303, the eNB 303 may select the MME 305 from the RRC request message. In various embodiments, the RRC request message carries the old Globally Unique MME Identifier (“GUMMEI”) comprising a PLMN identity, an MME group identity, and an MME code, where the MME code may be used by the NAS node selection function of the eNB 303, to select the MME 305 according to subclause 6.2.3 of 3GPP TS 36.401. In various embodiments, the GUMMEI follows the format defined in 3GPP TS 23.003.

If the MME indicated in the GUMMEI is not associated with the eNB 303—or if the old GUMMEI is not available, then the eNB 303 may select an MME 305 as described in clause 4.3.8.3 of 3GPP TS 24.301, where the “MME selection function” has been described. According to that clause, the eNB 303 makes selection of the MME 305 based on the GUMMEI with or without distinguishing on mapped from a Packet Temporary Mobile Subscriber Identity (“P-TMSI”) and/or Routing Area Identifier (“RAI”) or is a native GUMMEI. If Dedicated Core Network (“DCN”) is deployed and the UE-assisted DCN selection feature is supported, the UE 301 may provide a DCN Identifier (“DCN-ID”) to the eNB 303 to be used for MME selection. According to clause 4.3.8.3 of 3GPP TS 24.301: “if UE-assisted DCN selection feature is supported and a DCN-ID is provided by the UE, the DCN-ID shall be used in the eNB for MME selection to maintain the same DCN when the serving MME is not available.”

Having selected the MME 305, the eNB 303 sends an Initial UE message comprising the above-described Attach request (see signaling 317).

At Step 3, if the MME 305 has not been changed since the last detach, then the MME 305 may use the Globally Unique Temporary Identifier (“GUTI”) received from the UE 301 to verify the UE's identity. If the MME 305 has been changed since the last detach, then the MME 305 may use the GUTI received from the UE 301 to derive the old MME/Serving GPRS Support Node (“SGSN”) address, in order to request for the UE's identity and any available UE context. If the UE 301 is unknown to the MME 305, then the MME 305 may request for the UE's International Mobile Subscriber Identity (“IMSI”), and the network may authenticate the UE 301. As used herein, a “UE context” refers to a set of information associated with an individual, active UE and containing the necessary information required to maintain RAN services towards the active UE.

In some embodiments, the MME 305 selects the SGW 307 based on network topology, i.e., the selected SGW 307 serves the UE's location and for overlapping SGW 307 service areas, the selection may prefer SGW 307s with service areas that reduce the probability of changing the SGW 307.

In some embodiments, the UE 301 supporting UAS services may have included one or more APN for one or more PDN for the UAS services in any request (e.g., initial request or handover request). In certain embodiments, the subscription context, which is provided by the HSS 311, for the UE 301 supporting UAS services may include one or more APNs for one or more PDNs for the UAS services. The one or more PDNs are used for identifying one or more PGWs capable of UAS services. The subscription context provides which of the one or more PDNs provided by the UE 301 are in subscription contexts and which of them are the default ones for the UE 301.

Since the request type is “initial request,” if the UE 301 has not provided any APN and the subscription context from the HSS 311 contains a PGW identity corresponding to the default APN, then the MME 305 uses the PGW 309 corresponding to the default APN for default bearer activation. While if the UE 301 provided an APN and the APN is for accessing the UAS NF, the MME 305 selects the appropriate PGW corresponding to the provided APN for default bearer activation.

In various embodiments, the MME 305 requests the HSS 311 for the aerial subscription information of the UE 301 along with the UE's subscription data, e.g., as described in 3GPP TS 29.272. In one embodiment, the MME 305 sends a Retrieve UE aerial subscription information request (or similar message) to the HSS 311 (see signaling 319) and receives a Retrieve UE aerial subscription information response (or similar message) containing the UE's aerial subscription information (see signaling 321).

If DCN with dedicated SGW 307 and PGW 309 is used, then the Domain Name System (“DNS”) procedure for SGW 307 selection and PGW 309 selection may be used such that a SGW 307 and a PGW 309 belonging to a DCN serving the UE 301 supporting UAS services.

When the MME 305 supports ePCO, then the extended PCO support indication is set to ‘1’ on S11 interface by the MME 305 to inform the SGW 307 is supported by the UE 301 and MME 305 (e.g., as described in 3GPP TS 29.274) and the MME 305 sends a create session request message to the SGW 307 (see signaling 323). The MME 305 may also use the kind of the container ID within the ePCO IE which is specifically for the UUAA to identify that the attach request is for the UUAA procedure. Thus, the MME 305 may request the UE's aerial subscription information with the UE's subscription data from the HSS 311, e.g., as described in 3GPP TS 29.272 (see signaling 319 and 321).

At Step 4, the SGW 307 creates a new entry in its EPS bearer context table and sends a Create Session request message comprising the APN, a SGW address, a PDN address, a subscribed APN and PCO towards the PGW 309 indicated by the PGW address received in the previous step (see signaling 325). If the SGW 307 supports ePCO, then the SGW 307 sets the extended PCO support indication to ‘1’ on S5/S8 interface (e.g., as described in 3GPP TS 29.274) to show the support for ePCO by the UE 301, MME 305 and SGW 307 to PGW 309.

At Step 5, the PGW 309 receives the Create Session request message comprising the ePCO IE and if the UUAA is successful, the PGW 309 may create a new entry in its EPS bearer context table. Additionally, the PGW 309 returns a Create Session response message to the SGW 307 (see signaling 327), e.g., according to 3GPP TS 29.274. In certain embodiments, the Create Session response message sent towards the SGW 307 comprises the PGW address for the user plane, the PDN address and the indicator of ePCO support.

At Step 6, the SGW 307 returns a Create Session response message to the MME 305 (see signaling 329). Here, the Create Session response message may comprise the ePCO IE, e.g., according to 3GPP TS 29.274. The SGW 307 may buffer any data downlink packets it may receive from PGW 309 until it receives modify bearer request message from the MME 305.

At Step 7, the MME 305 sends to eNB 303, an Attach accept message, e.g., within an Initial Context Setup request message (see signaling 331). Here, the Attach accept message may comprise a Session Management request message used to establish a PDN connection which may be an ESM message container comprising:
the Activate EPS Bearer Context Request message (e.g., Activate Default EPS Bearer Context Request message); and
the EPS network feature support comprises ePCO support for the network.

In the depicted embodiment, the Attach accept request is transmitted within an S1AP Initial Context Setup request message (see signaling 331). The MME 305 may also include the Aerial UE subscription information IE with the value ‘allowed’ or ‘not allowed’ in the S1AP Initial Context Setup request message sent towards the eNB 303, see 3GPP TS 36.413.

At Step 8, upon receiving the S1AP Initial Context Setup request, the eNB 303 sends, to the UE 301, a RRC Connection Reconfiguration message including, e.g., the Attach accept message comprising ePCO support (see block 333).

Upon receipt of the RRC connection reconfiguration message, the UE 301 sends a RRC Connection Reconfiguration complete message to eNB 303, which may trigger the eNB 303 to transmit an Initial Context Setup response message to the MME 305 (see signaling 335).

At Step 9, the UE 301 may send a direct transfer message to the eNB 303, including an Attach complete message comprising an Activate EPS Bearer Context Accept message, e.g., contained in an ESM message container IE (see signaling 337). In one embodiment, the Activate EPS Bearer Context Accept message comprises an Activate Default EPS Bearer Context Accept message.

At Step 10, the eNB 303 may use an uplink NAS transport message to send the attach complete to the MME 305 (see signaling 339).

At Step 11, the MME 305 may use a Modify Bearer request message comprising parameters to enable the SGW 307 to transmit downlink data towards the UE 301 (see signaling 341).

At Step 12, the SGW 307 may return a Modify Bearer response message to the MME 305 (see signaling 341). Note that the SGW 307 may deliver to the MME 305 any data downlink packets stored in its buffer for the UE 301, for transmission towards the UE 301.

In the first solution, the UUAA may occur at the time of 5GS registration (referred to as UUAA-MM) or at the time of 5GS PDU session establishment.

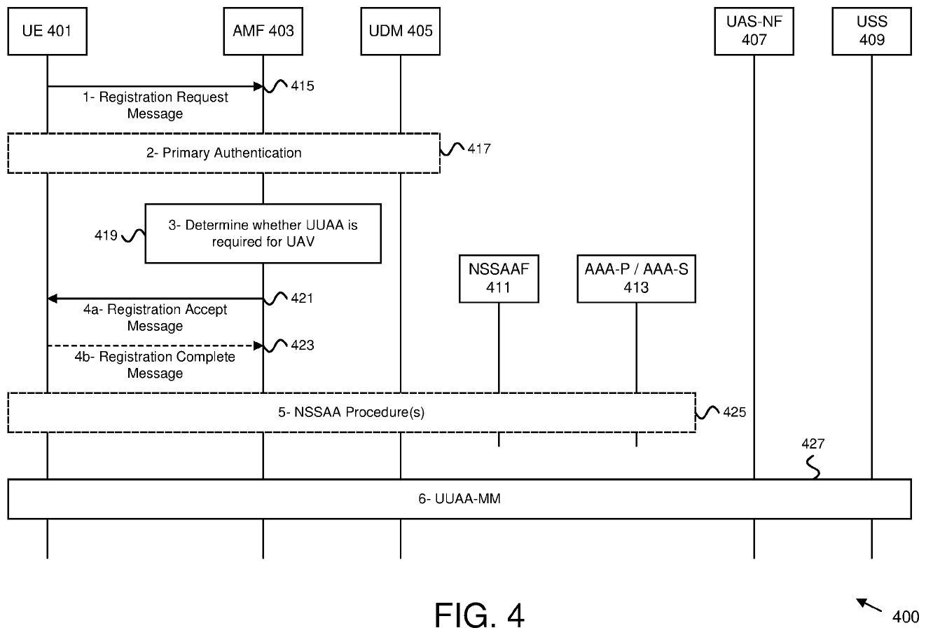

FIG. 4 depicts an exemplary procedure 400 for UUAA in the context of the Registration procedure, in accordance with aspects of the present disclosure. The procedure 400 involves a UE 401 (e.g., an embodiment of the UE 205 and/or the remote unit 105) associated with a UAV, an AMF 403 (e.g., and embodiment of the AMF 143), a UDM 405 (e.g., one embodiment of the UDM/UDR 149 and/or the HSS+UDM 169), a UAS NF 407 (e.g., one embodiment of the UAS NF 147 and/or UAS NF/NEF 161), and a USS 409 (e.g., one embodiment of the USS/UTM 151). If Network Slice-Specific Authentication and Authorization (“NSSAA”) is required, the procedure 400 may also involve a Network Slice-Specific Authentication and Authorization Function (“NSSAAF”) 411 and an AAA server (“AAA-S”) and/or AAA proxy (“AAA-P”) (depicted as combined entity AAA-S/AAA-P 413).

At Step 1, the UE 401 initiates the registration procedure by sending a Registration request message to the AMF 403 (see signaling 415). If configured with one, the UE 401 provides a CAA-level UAV ID of the UAV and, optionally, an USS address when registering for UAS services.

At Step 2, if primary authentication is required (e.g., if this is an initial Registration), then the AMF 403 invokes primary authentication between the UE 401 and the 5GC (see block 417). One example of primary authentication is described in Clause 4.2.2.2.2 of TS 23.502 (which clause is incorporated by reference), with reference to step 9 in FIG. 4.2.2.2.2-1. Subsequently, the AMF 403 retrieves the UE 401 subscription data from the UDM 405 (not shown in FIG. 4), e.g., as described in step 14 in FIG. 4.2.2.2.2-1 of 3GPP TS 23.502.

At Step 3, the AMF 403 determines whether UUAA-MM is required for the UAV (i.e., UE 401). The AMF 403 decides that UUAA is required if.
the UE 401 has a valid Aerial UE subscription information;
UUAA is to be performed during Registration according to local operator policy;
there is no successful UUAA result from a previous UUAA-MM procedure; and/or
the UE 401 has provided a CAA-Level UAV ID.

At Step 4, the AMF 403 sends a registration accept message to the UE 401 (see signaling 421) and the UE 401 responds by sending a registration complete message (see signaling 423).

At Step 5, the UE 401 performs NSSAA procedures with the NSSAAF 411 and AAA-P/AAA-S 413, if required (see block 425). One example of primary authentication is described in Clause 4.2.2.2.2 of 3GPP TS 23.502, with reference to step 25 in FIG. 4.2.2.2.2-1.

At Step 6, if required based on the determination in step 3, and if the S-NSSAI that is associated with the UAS services is part of the Allowed NSSAI, then the UUAA-MM procedure is executed at this step (see block 427). One example of UUAA-MM procedure is described in Clause 5.2.2.2 of 3GPP TS 23.256 (which clause is incorporated by reference).

Once the UUAA-MM procedure is successfully completed for the UAV, the AMF 403 stores a successful UUAA result and updates the UE 401 context indicating that UUAA is no longer pending and with an optional authorized/new CAA-Level UAV ID received from the USS 409.

Additionally, the AMF 403 triggers a UE Configuration Update procedure (e.g., as described in 3GPP TS 23.502, clause 4.2.4.2) to deliver the UUAA result and the UUAA Authorization Payload containing UAV configuration to the UE 401. The AMF 403 may also transmit the Aerial UE subscription information IE with the value allowed or not allowed towards the gNB (not shown in FIG. 4) as a new IE in PDU SESSION RESOURCE SETUP REQUEST. As an example, implementation of the above may be realized by modifying 3GPP TS 38.413 to add the optional IE “Aerial UE subscription information” to the PDU Session Resource Setup Request as illustrated in Table 1.

TABLE 1

| | | | | | | |
|---|---|---|---|---|---|---|
| | | | IE type and | Semantics | | Assigned |
| IE/Group Name | Presence | Range | reference | description | Criticality | Criticality |

| | | | | |
|---|---|---|---|---|
| Aerial UE | O | 9.3.1.X (see | YES | ignore |
| subscription | | Table 2, below) | | |
| information | | | | |

An exemplary definition of the Aerial UE subscription information IE is illustrated in Table 2. This information element is used by the gNB to know if the UE is allowed to use UAS function and how the UE is identified for UAS services by 3GPP network, see 3GPP TS 23.256.

TABLE 2

| | | | | |
|---|---|---|---|---|
| | | | IE type and | Semantics |
| IE/Group Name | Presence | Range | reference | description |

| | | |
|---|---|---|
| aerialSubscribed | M | ENUMERATED |
| | | (allowed, not |
| | | allowed, . . . ) |

If the UUAA is performed for 5GS at the time of the PDU session establishment, the AMF 403, at the time the AMF 403 receives the “201 OK” message created message of the PDU session establishment for the UUAA-SM, may transmit the Aerial UE subscription information, as described in U.S. Provisional Patent Application No. 63/271,671 titled “APPARATUSES, METHODS, AND SYSTEMS FOR TRANSMISSION OF PROTOCOL CONFIGURATION OPTIONS” filed on 25 Oct. 2021 for Roozbeh Atarius and Dimitrios Karampatsis, which application is incorporated by reference.

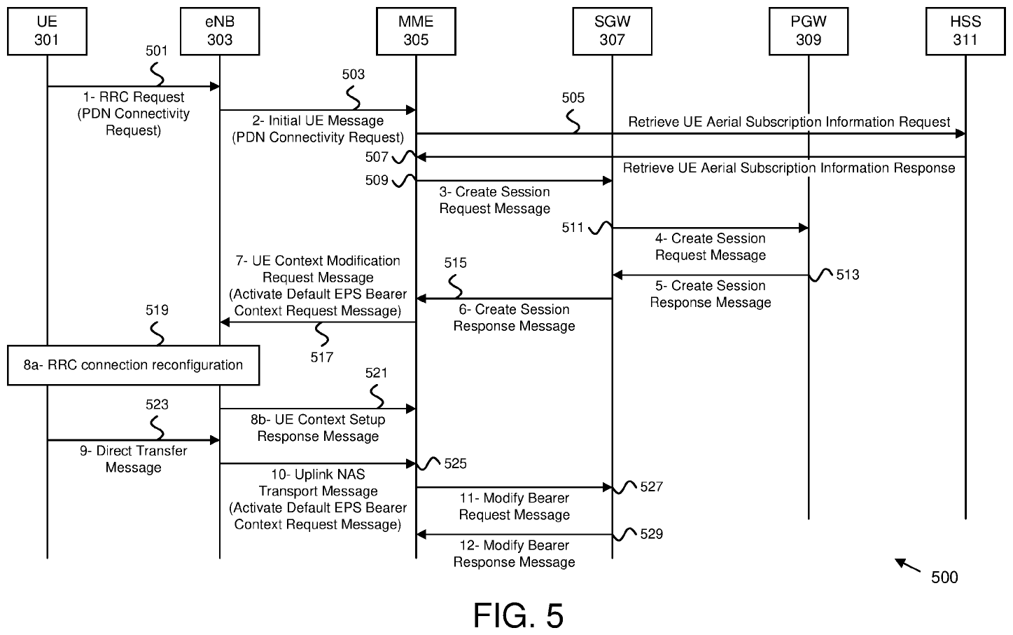

According to embodiments of the second solution, the UE 205 may already be attached to the EPS and may be in EMM-IDLE mode. Accordingly, the UE 205 is to perform the UUAA by establishing a PDN connection by first going to EMM-CONNECTED mode, according to FIG. 5.

FIG. 5 depicts an exemplary procedure 500 for UUAA and C2 authorization at PDN connection establishment when the UE is already registered to EPS, in accordance with aspects of the present disclosure. The procedure 500 involves the UE 301, the eNB 303, the MME 305, the SGW 307, the PGW 309, and the HSS 311, which entities may be substantially as described above with reference to FIG. 3.

At Step 1, the UE 301 sends a PDN connectivity request message to the eNB 303 (see signaling 501). In various embodiments, the PDN connectivity request message is based on the message defined in 3GPP TS 24.501 and comprises:
an APN set to the value for establishing bearer for the UAS services, in order to indicate the desired PGW 309 to the MME 305;
a UE network capability IE with the bit set to indicate the support for the ePCO IE; and
an ePCO IE with the length two octets, e.g., as defined in subclause 10.5.6.3A in 3GPP TS 24.008.

The ePCO IE is chosen (i.e., rather than the (PCO IE with the length one octet as defined in subclause 10.5.6.3 in 3GPP TS 24.008), due to the amount of the information to be sent being larger than 255 octets. This is because during that the PDN connectivity and the UUAA, the UE 301 is required to transmit the following information which may comprise:
the CAA-Level UAV ID of the UAV;
the USS address; and
the UUAA aviation payload.

Furthermore, if the UE 301 also considers authorization for C2 communications, the UE is to additionally transmit the following information which:
the UAS container comprising UAV UAV-C pairing information; and
the flight authorization information.

The UE 301 may use the service-level-AA IE as defined in 3GPP TS 24.501. The ePCO has a specific container ID which is specific for the UUAA procedure. In some embodiments, the UE 301 uses the RRC request message including the attach request to the network for an RRC connection.

At Step 2, upon receipt of the RRC request message, the eNB 303 may forward the PDN connectivity request message to the selected the MME 305 (see signaling 503), which determines that the PDN connectivity request message is to establish a bearer (e.g., default bearer) with a selected APN.

At Step 3, the UE 301 supporting UAS services may have included one or more APN for one or more PDN for the UAS services in any request (e.g., initial request or handover request). In certain embodiments, the subscription context, which is provided by the HSS 311, for the UE 301 supporting UAS services may include one or more APNs for one or more PDNs for the UAS services. The one or more PDNs are used for identifying one or more PGWs capable of UAS services. The subscription context provides which of the one or more PDNs provided by the UE 301 are in subscription contexts and which of them are the default ones for the UE 301. Since the UE 301 has provided an APN and the APN is for accessing the UAS NF 147, the MME 305 selects the appropriate the PGW 309 corresponding to the provided APN for default bearer activation.

In various embodiments, the MME 305 requests the HSS 311 for the aerial subscription information of the UE 301 along with the UE's subscription data, e.g., as described in 3GPP TS 29.272. In one embodiment, the MME 305 sends a Retrieve UE aerial subscription information request (or similar message) to the HSS 311 (see signaling 505) and receives a Retrieve UE aerial subscription information response (or similar message) containing the UE's aerial subscription information (see signaling 507).

When the MME 305 supports ePCO, then the extended PCO support indication is set to ‘1’ on S11 interface by the MME 305 to inform the SGW 307 is supported by the UE 301 and MME 305 (e.g., as described in 3GPP TS 29.274) and the MME 305 sends a create session request message to the SGW 307 (see signaling 323). The MME 305 may also use the kind of the container ID within the ePCO IE which is specifically for the UUAA to identify that the attach request is for the UUAA procedure. Thus, the MME 305 may request the UE's aerial subscription information with the UE's subscription data from the HSS 311, e.g., as described in 3GPP TS 29.272 (see signaling 505 and 507).

At Step 4, the SGW 307 creates a new entry in its EPS bearer context table and sends a Create Session request message comprising the APN, a SGW address, a PDN address, a subscribed APN and PCO towards the PGW 309 indicated by the PGW address received in the previous step (see signaling 509). If the SGW 307 supports ePCO, then the SGW 307 sets the extended PCO support indication to ‘1’ on S5/S8 interface (e.g., as described in 3GPP TS 29.274) to show the support for ePCO by the UE 301, MME 305 and SGW 307 to PGW 309.

At Step 5, the PGW 309 receives the Create Session request message comprising the ePCO IE and if the UUAA is successful, the PGW 309 may create a new entry in its EPS bearer context table. Additionally, the PGW 309 returns a Create Session response message to the SGW 307 (see signaling 511), e.g., according to 3GPP TS 29.274. In certain embodiments, the Create Session response message sent towards the SGW 307 comprises the PGW address for the user plane, the PDN address and the indicator of ePCO support.

At Step 6, the SGW 307 returns a Create Session response message to the MME 305 (see signaling 513). Here, the Create Session response message may comprise the ePCO IE, e.g., according to 3GPP TS 29.274. The SGW 307 may buffer any data downlink packets it may receive from PGW 309 until it receives modify bearer request message from the MME 305.

At Step 7, the MME 305 sends to the eNB 303, an Activate EPS Bearer Context Request message, e.g., within an S1AP UE Context Modification request message (see signaling 515). Here, the Activate EPS Bearer Context Request message may contain a service accept message. The MME 305 may also include the Aerial UE subscription information IE with the value ‘allowed’ or ‘not allowed’ in the S1AP UE Context Modification request message towards the eNB 303, see 3GPP TS 36.413. In one embodiment, the Activate EPS Bearer Context Request message comprises an Activate Default EPS Bearer Context Request message.

At Step 8, upon receiving the S1AP UE context modification request, the eNB 303 sends, to the UE 301, a RRC Connection Reconfiguration message including, e.g., the service accept message (see block 517).

Upon receipt of the RRC connection reconfiguration message, the UE 301 sends the RRC Connection Reconfiguration complete message to the eNB 303, which may trigger the eNB 303 to transmit a UE Context Modification response message to the MME 305 (see signaling 519).

At Step 9, the UE 301 may send a direct transfer message to the eNB 303, including the Activate EPS Bearer Context Accept message, e.g., contained in an ESM message container IE (see signaling 523). In one embodiment, the Activate EPS Bearer Context Accept message comprises an Activate Default EPS Bearer Context Accept message.

At Step 10, the eNB 303 may use an uplink NAS transport message to send the Activate EPS Bearer Context Accept message to the MME 305, e.g., contained in an Uplink NAS transport message (see signaling 525).

At Step 11, the MME 305 may use a Modify Bearer request message comprising parameters to enable the SGW 307 to transmit downlink data towards the UE 301 (see signaling 527).

At Step 12, the SGW 307 may return a Modify Bearer response message to the MME 305 (see signaling 529). If any data for the UE 301 is buffered at the SGW 307, it can now be transmitted towards the UE 301.

According to embodiments of the third solution, a UE 205 may change coverage from EPS to 5GS or vice versa. If the UE 205 is registered for the UAS services and the related PDN connection or the PDU session needs to be transferred to the new access control which may be 5GS or EPS, the AMF 143 or MME 131 retrieves the UE context including the Aerial UE subscription information comprising allowed or not allowed at the time of handover of the related PDN connection or PDU session. The AMF 143 or MME 131 can then inform the new RAN node (which may eNB or gNB) about the Aerial UE subscription information of the UE 205 by using an Initial Context Setup request message.

Another way to retrieve this information may be the direct interaction between the old RAN node (e.g., eNB or gNB) and the new RAN node. In various embodiments, an eNB may be capable to communicate with gNB via Xn interface (e.g., described in 3GPP TS 38.423) and retrieve the UE context comprising the Aerial UE subscription information of the UE 205, e.g., comprising the value ‘allowed or ‘not allowed.’

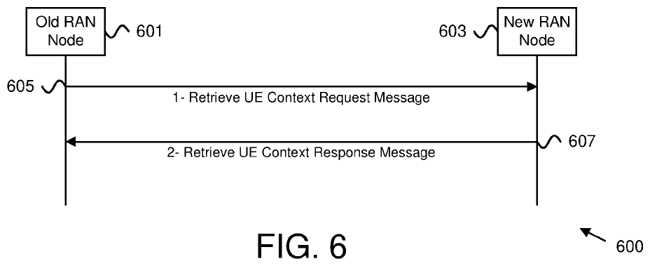

FIG. 6 depicts an exemplary procedure 600 for retrieving a UE context, e.g., of a UAV, in accordance with aspects of the present disclosure. The procedure 600 involves an old RAN node 601 (e.g., an eNB or a gNB) and a new RAN 603 (e.g., an eNB or a gNB). The procedure 600 shows an example of how the new RAN node 603 may fetch a UE's Aerial subscription information (which may be in the UE context) from the old RAN node 601.

At Step 1, the new RAN node 603 send a context retrieval request to the old RAN node 601 (see signaling 605). In some embodiments, the context retrieval request may comprise a RETRIEVE UE CONTEXT REQUEST message, or similar message.

At Step 2, the old RAN send a context retrieval response to the new RAN node 601 (see signaling 607). In some embodiments, the context retrieval response may comprise a RETRIEVE UE CONTEXT RESPONSE message, or similar message.

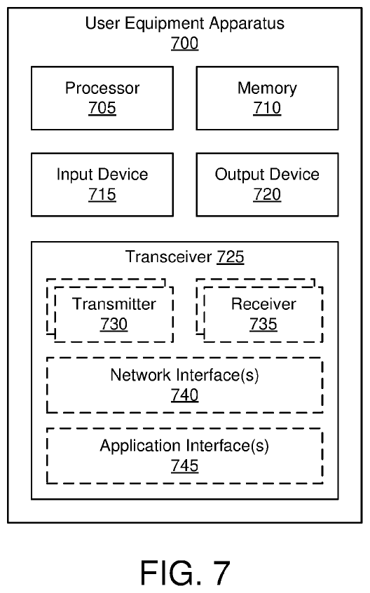

FIG. 7 illustrates an example of a user equipment apparatus 700 that may be used for distributing aerial subscription information, in accordance with aspects of the present disclosure. In various embodiments, the user equipment apparatus 700 is used to implement one or more of the solutions described above. The user equipment apparatus 700 may be an example of a user endpoint, such as the remote unit 105, the UE 205, the UE 301, and/or the UE 401, as described above. Furthermore, the user equipment apparatus 700 may include a processor 705, a memory 710, an input device 715, an output device 720, and a transceiver 725.

In some embodiments, the input device 715 and the output device 720 are combined into a single device, such as a touchscreen. In certain embodiments, the user equipment apparatus 700 may not include any input device 715 and/or output device 720. In various embodiments, the user equipment apparatus 700 may include one or more of: the processor 705, the memory 710, and the transceiver 725, and may not include the input device 715 and/or the output device 720.

As depicted, the transceiver 725 includes at least one transmitter 730 and at least one receiver 735. In some embodiments, the transceiver 725 communicates with one or more cells (or wireless coverage areas) supported by one or more base station units 121. In various embodiments, the transceiver 725 is operable on unlicensed spectrum. Moreover, the transceiver 725 may include multiple UE panels supporting one or more beams. Additionally, the transceiver 725 may support at least one network interface 740 and/or application interface 745. The application interface(s) 745 may support one or more APIs. The network interface(s) 740 may support 3GPP reference points, such as Uu, N1, PC5, etc. Other network interfaces 740 may be supported, as understood by one of ordinary skill in the art.

The processor 705, in one embodiment, may include any known controller capable of executing computer-readable instructions and/or capable of performing logical operations. For example, the processor 705 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 705 executes instructions stored in the memory 710 to perform the methods and routines described herein. The processor 705 is communicatively coupled to the memory 710, the input device 715, the output device 720, and the transceiver 725.

In various embodiments, the processor 705 controls the user equipment apparatus 700 to implement the above-described UE behaviors. In certain embodiments, the processor 705 may include an application processor (also known as “main processor”) which manages application-domain and operating system (“OS”) functions and a baseband processor (also known as “baseband radio processor”) which manages radio functions.

The memory 710, in one embodiment, is a computer readable storage medium. In some embodiments, the memory 710 includes volatile computer storage media. For example, the memory 710 may include a random-access memory (“RAM”), including dynamic RAM (“DRAM”), synchronous dynamic RAM (“SDRAM”), and/or static RAM (“SRAM”). In some embodiments, the memory 710 includes non-volatile computer storage media. For example, the memory 710 may include a hard disk drive, a flash memory, or any other suitable non-volatile computer storage device. In some embodiments, the memory 710 includes both volatile and non-volatile computer storage media.

In some embodiments, the memory 710 stores data related to distributing aerial subscription information. For example, the memory 710 may store parameters, configurations, and the like as described above. In certain embodiments, the memory 710 also stores program code and related data, such as an operating system or other controller algorithms operating on the user equipment apparatus 700.

The input device 715, in one embodiment, may include any known computer input device including a touch panel, a button, a keyboard, a stylus, a microphone, or the like. In some embodiments, the input device 715 may be integrated with the output device 720, for example, as a touchscreen or similar touch-sensitive display. In some embodiments, the input device 715 includes a touchscreen such that text may be input using a virtual keyboard displayed on the touchscreen and/or by handwriting on the touchscreen. In some embodiments, the input device 715 includes two or more different devices, such as a keyboard and a touch panel.

The output device 720, in one embodiment, is designed to output visual, audible, and/or haptic signals. In some embodiments, the output device 720 includes an electronically controllable display or display device capable of outputting visual data to a user. For example, the output device 720 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 720 may include a wearable display separate from, but communicatively coupled to, the rest of the user equipment apparatus 700, such as a smart watch, smart glasses, a heads-up display, or the like. Further, the output device 720 may be a component of a smart phone, a personal digital assistant, a television, a table computer, a notebook (laptop) computer, a personal computer, a vehicle dashboard, or the like.

In certain embodiments, the output device 720 includes one or more speakers for producing sound. For example, the output device 720 may produce an audible alert or notification (e.g., a beep or chime). In some embodiments, the output device 720 includes one or more haptic devices for producing vibrations, motion, or other haptic feedback. In some embodiments, all or portions of the output device 720 may be integrated with the input device 715. For example, the input device 715 and output device 720 may form a touchscreen or similar touch-sensitive display. In other embodiments, the output device 720 may be located near the input device 715.

The transceiver 725 communicates with one or more network functions of a mobile communication network via one or more access networks. The transceiver 725 operates under the control of the processor 705 to transmit messages, data, and other signals and also to receive messages, data, and other signals. For example, the processor 705 may selectively activate the transceiver 725 (or portions thereof) at particular times in order to send and receive messages.

The transceiver 725 includes at least one transmitter 730 and at least one receiver 735. One or more transmitters 730 may be used to provide UL communication signals to a base station unit 121, such as the UL transmissions described herein. Similarly, one or more receivers 735 may be used to receive DL communication signals from the base station unit 121, as described herein. Although only one transmitter 730 and one receiver 735 are illustrated, the user equipment apparatus 700 may have any suitable number of transmitters 730 and receivers 735. Further, the transmitter(s) 730 and the receiver(s) 735 may be any suitable type of transmitters and receivers.

In one embodiment, the transceiver 725 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example, a single chip performing functions for use with both licensed and unlicensed radio spectrum. In some embodiments, the first transmitter/receiver pair and the second transmitter/receiver pair may share one or more hardware components. For example, certain transceivers 725, transmitters 730, and receivers 735 may be implemented as physically separate components that access a shared hardware resource and/or software resource, such as for example, the network interface 740.

In various embodiments, one or more transmitters 730 and/or one or more receivers 735 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 730 and/or one or more receivers 735 may be implemented and/or integrated into a multi-chip module. In some embodiments, other components such as the network interface 740 or other hardware components/circuits may be integrated with any number of transmitters 730 and/or receivers 735 into a single chip. In such embodiment, the transmitters 730 and receivers 735 may be logically configured as a transceiver 725 that uses one or more common control signals or as modular transmitters 730 and receivers 735 implemented in the same hardware chip or in a multi-chip module.

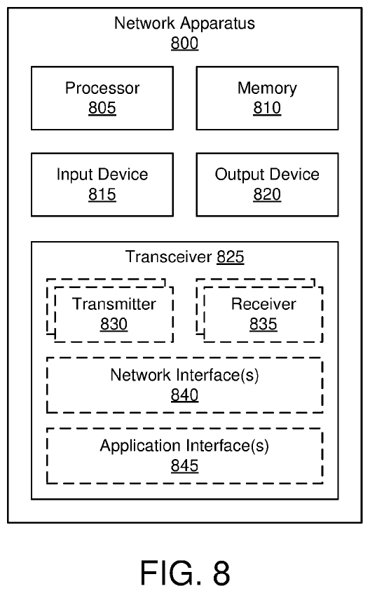

FIG. 8 illustrates an example of a network apparatus 800 that may be used for distributing aerial subscription information, in accordance with aspects of the present disclosure. In one embodiment, the network apparatus 800 may be one implementation of a network endpoint, such as the base station unit 121 and/or RAN node 210, as described above. In another embodiment, the network apparatus 800 may be an implementation of a network entity, such as the MME 131 and/or the MME 305. Furthermore, the network apparatus 800 may include a processor 805, a memory 810, an input device 815, an output device 820, and a transceiver 825.

In some embodiments, the input device 815 and the output device 820 are combined into a single device, such as a touchscreen. In certain embodiments, the network apparatus 800 may not include any input device 815 and/or output device 820. In various embodiments, the network apparatus 800 may include one or more of: the processor 805, the memory 810, and the transceiver 825, and may not include the input device 815 and/or the output device 820.

As depicted, the transceiver 825 includes at least one transmitter 830 and at least one receiver 835. Here, the transceiver 825 communicates with one or more remote units 85. Additionally, the transceiver 825 may support at least one network interface 840 and/or application interface 845. The application interface(s) 845 may support one or more APIs. The network interface(s) 840 may support 3GPP reference points, such as Uu, N1, N2 and N3. Other network interfaces 840 may be supported, as understood by one of ordinary skill in the art.

The processor 805, in one embodiment, may include any known controller capable of executing computer-readable instructions and/or capable of performing logical operations. For example, the processor 805 may be a microcontroller, a microprocessor, a CPU, a GPU, an auxiliary processing unit, a FPGA, or similar programmable controller. In some embodiments, the processor 805 executes instructions stored in the memory 810 to perform the methods and routines described herein. The processor 805 is communicatively coupled to the memory 810, the input device 815, the output device 820, and the transceiver 825.

In various embodiments, the network apparatus 800 is a RAN node (e.g., gNB) that communicates with one or more UEs and one or more NFs, as described herein. In such embodiments, the processor 805 controls the network apparatus 800 to perform the above-described RAN behaviors. When operating as a RAN node, the processor 805 may include an application processor (also known as “main processor”) which manages application-domain and operating system (“OS”) functions and a baseband processor (also known as “baseband radio processor”) which manages radio functions.

In some embodiments, via the transceiver 825, the processor 805 receives, from an UAV, a first request message for a service AA procedure and transmits, to a first network entity, a second request message for the service AA procedure. In some embodiments, the first network entity comprises a MME. In one embodiment, the first request message comprises an indication that the first request message is for a service AA procedure. In one embodiment, the second message comprises an indication that the first request message is for a service AA procedure.

In some embodiments, via the transceiver 825, the processor 805 receives, from the first network entity, a first response message comprising aerial subscription information corresponding to the UAV and a result of the service AA procedure, and transmits, to the UAV, a third request message to reconfigure a radio connection.

In certain embodiments, the processor 805 further determines a lost connection to the UAV and, via the transceiver 825, forwards a UE context comprising the aerial subscription information to a RAN node. In certain embodiments, the aerial subscription information comprises a value indicating whether an UAS service is allowed or unallowed.

In certain embodiments, the processor 805 further enables one or more features based at least in part on the result of the service AA procedure. In various embodiments, the one or more features include: A) an aerial height comprising a lower threshold and an upper threshold; B) location information comprising a horizontal velocity and a vertical velocity; C) flight path information; D) an open loop power control parameter to calculate a pathloss compensation factor; E) an interference detection based on UAV reporting measurements, or F) a combination thereof.

In various embodiments, the network apparatus 800 is an MME that communicates with one or more NFs, as described herein. In such embodiments, the processor 805 controls the network apparatus 800 to perform the above-described RAN behaviors. In some embodiments, via the transceiver 825, the processor 805 receives, from a first network entity, a first request message for a service AA procedure. In some embodiments, the first network entity comprises a RAN node associated with the UAV. In one embodiment, the first request message comprises an indication that the first request message is for a service AA procedure.

In some embodiments, first request message comprises an ePCO IE including: A) a container identity; and B) a Service-level AA container IE comprising a CAA-level UAV ID and either 1) a USS address; 2) a UUAA aviation payload; or 3) both. In certain embodiments, the container identity in the ePCO IE indicates that the first request message is for the service AA procedure.

In some embodiments, the first request message comprises an APN associated with establishing a default bearer for UAS services. In certain embodiments, the APN indicates that the first request message is for the service AA procedure.

In some embodiments, the first request message comprises an Attach Request message, the service AA procedure comprises an UUAA procedure, and the third request message comprises an Initial Context Setup Request message comprising an attach accept message.

In some embodiments, the first request message comprises a PDN Connectivity Request message, the service AA procedure comprises an UUAA procedure, and the third request message comprises a UE Context Modification Request message.

In some embodiments, the processor 805 controls the transceiver 825 to receive, from a second network entity, aerial subscription information corresponding to an UAV associated with the first request message. In some embodiments, the second network entity comprises a HSS. In one embodiment, the apparatus 800 retrieves the aerial subscription information directly from the HSS.

In some embodiments, the aerial subscription information comprises a value indicating whether an UAS service is allowed or unallowed. In certain embodiments, the aerial subscription information comprises a value selected from the group consisting of: 1) ‘allowed;’ or 2) ‘not allowed.’ In such embodiments, the value ‘allowed’ indicates permission to use an UAS service, and wherein the value ‘not allowed’ indicates a denial of use of the UAS service.

Via the transceiver 825, the processor 805 transmits, to a third network entity, a second request message for the service AA procedure and receives, from the third network entity, a first response message indicating a result of the service AA procedure. In one embodiment, the second message comprises an indication that the first request message is for the service AA procedure.

In some embodiments, the third network entity comprises a SGW associated with a PGW (e.g., a combined PGW-C and SMF entity). In such embodiments, the second request message may comprise a Create Session Request message, and the first response message may comprise a Create Session Response message comprising an Activate EPS Bearer Context Request message. In one embodiment, the Activate EPS Bearer Context Request message comprises an Activate Default EPS Bearer Context Request message.

In some embodiments, the processor 805 controls the transceiver 825 to transmit a third request message comprising the aerial subscription information and the result of the service AA procedure. In certain embodiments, the transceiver 825 transmits the third request message to the first network entity.

The memory 810, in one embodiment, is a computer readable storage medium. In some embodiments, the memory 810 includes volatile computer storage media. For example, the memory 810 may include a RAM, including DRAM, SDRAM, and/or SRAM. In some embodiments, the memory 810 includes non-volatile computer storage media. For example, the memory 810 may include a hard disk drive, a flash memory, or any other suitable non-volatile computer storage device. In some embodiments, the memory 810 includes both volatile and non-volatile computer storage media.

In some embodiments, the memory 810 stores data related to distributing aerial subscription information. For example, the memory 810 may store parameters, configurations, and the like, as described above. In certain embodiments, the memory 810 also stores program code and related data, such as an operating system or other controller algorithms operating on the network apparatus 800.

The input device 815, in one embodiment, may include any known computer input device including a touch panel, a button, a keyboard, a stylus, a microphone, or the like. In some embodiments, the input device 815 may be integrated with the output device 820, for example, as a touchscreen or similar touch-sensitive display. In some embodiments, the input device 815 includes a touchscreen such that text may be input using a virtual keyboard displayed on the touchscreen and/or by handwriting on the touchscreen. In some embodiments, the input device 815 includes two or more different devices, such as a keyboard and a touch panel.

The output device 820, in one embodiment, is designed to output visual, audible, and/or haptic signals. In some embodiments, the output device 820 includes an electronically controllable display or display device capable of outputting visual data to a user. For example, the output device 820 may include, but is not limited to, an LCD display, an LED display, an OLED display, a projector, or similar display device capable of outputting images, text, or the like to a user. As another, non-limiting, example, the output device 820 may include a wearable display separate from, but communicatively coupled to, the rest of the network apparatus 800, such as a smart watch, smart glasses, a heads-up display, or the like. Further, the output device 820 may be a component of a smart phone, a personal digital assistant, a television, a table computer, a notebook (laptop) computer, a personal computer, a vehicle dashboard, or the like.

In certain embodiments, the output device 820 includes one or more speakers for producing sound. For example, the output device 820 may produce an audible alert or notification (e.g., a beep or chime). In some embodiments, the output device 820 includes one or more haptic devices for producing vibrations, motion, or other haptic feedback. In some embodiments, all or portions of the output device 820 may be integrated with the input device 815. For example, the input device 815 and output device 820 may form a touchscreen or similar touch-sensitive display. In other embodiments, the output device 820 may be located near the input device 815.

The transceiver 825 includes at least one transmitter 830 and at least one receiver 835. One or more transmitters 830 may be used to communicate with the UE, as described herein. Similarly, one or more receivers 835 may be used to communicate with network functions in the PLMN and/or RAN, as described herein. Although only one transmitter 830 and one receiver 835 are illustrated, the network apparatus 800 may have any suitable number of transmitters 830 and receivers 835. Further, the transmitter(s) 830 and the receiver(s) 835 may be any suitable type of transmitters and receivers.

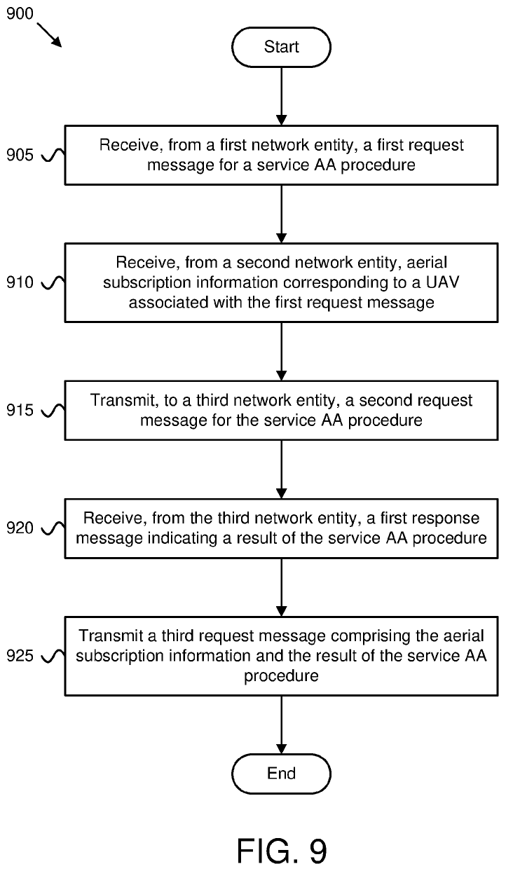

FIG. 9 illustrates a flowchart of a method 900 for distributing aerial subscription information, in accordance with aspects of the present disclosure. The operations of the method 900 may be implemented by a network entity, such as the MME 131, the MME 305, and/or the network apparatus 800 (or components thereof), as described herein. Additionally, or alternatively, the operations of the method 900 may be performed by a processor executing program code, for example, a microcontroller, a microprocessor, a CPU, a GPU, an auxiliary processing unit, a FPGA, or the like.

The method 900 includes receiving 905, from a first network entity, a first request message for a service AA procedure. The method 900 includes receiving 910, from a second network entity, aerial subscription information corresponding to a UAV associated with the first request message. The method 900 includes transmitting 915, to a third network entity, a second request message for the service AA procedure. The method 900 includes receiving 920, from the third network entity, a first response message indicating a result of the service AA procedure. The method 900 includes transmitting 925 a third request message comprising the aerial subscription information and the result of the service AA procedure.

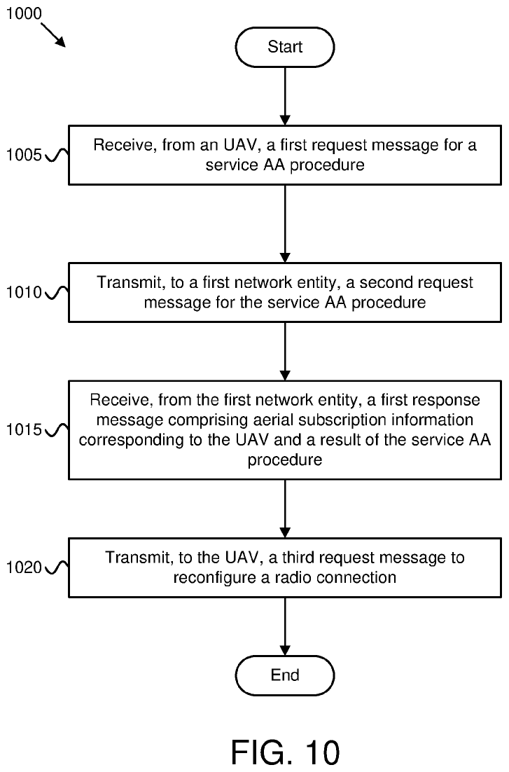

FIG. 10 illustrates a flowchart of a method 1000 for distributing aerial subscription information, in accordance with aspects of the present disclosure. The operations of the method 1000 may be implemented by a network entity, such as a base station unit 121, the RAN node 210, the eNB 303, and/or the network apparatus 800 (or components thereof), as described herein. Additionally, or alternatively, the operations of the method 1000 may be performed by a processor executing program code, for example, a microcontroller, a microprocessor, a CPU, a GPU, an auxiliary processing unit, a FPGA, or the like.

The method 1000 includes receiving 1005, from a UAV, a first request message for a service AA procedure. The method 1000 includes transmitting 1010, to a first network entity, a second request message for the service AA procedure. The method 1000 includes receiving 1015, from the first network entity, a first response message comprising aerial subscription information corresponding to the UAV and a result of the service AA procedure. The method 1000 includes transmitting 1020, to the UAV, a third request message to reconfigure a radio connection.

Disclosed herein is a first apparatus for distributing aerial subscription information, in accordance with aspects of the present disclosure. The first apparatus may be implemented by a network entity, such as the MME 131, the MME 305, and/or the network apparatus 800, as described above. The first apparatus includes a processor coupled to a memory, the memory including instructions executable by the processor to cause the apparatus to: A) receive, from a first network entity, a first request message for a service AA procedure; B) receive, from a second network entity, aerial subscription information corresponding to an UAV associated with the first request message; C) transmit, to a third network entity, a second request message for the service AA procedure; D) receive, from the third network entity, a first response message indicating a result of the service AA procedure; and E) transmit a third request message including the aerial subscription information and the result of the service AA procedure.

In some embodiments, first request message includes an ePCO IE including: 1) a container identity; and 2) a Service-level AA container IE including A) a CAA-level UAV ID and B) at least one or more of: i) a USS address; ii) a UUAA aviation payload; or iii) a combination thereof. In certain embodiments, the container identity in the ePCO IE indicates that the first request message is for the service AA procedure.

In some embodiments, the first request message includes an APN associated with establishing a default bearer for UAS services. In certain embodiments, the APN indicates that the first request message is for the service AA procedure.

In some embodiments, the first request message includes an Attach Request message, the service AA procedure includes an UUAA procedure, and the third request message includes an Initial Context Setup Request message including an attach accept message.

In some embodiments, the first request message includes a PDN Connectivity Request message, the service AA procedure includes an UUAA procedure, and the third request message includes a UE Context Modification Request message.

In some embodiments, the third network entity includes a SGW associated with a PGW, the second request message includes a Create Session Request message, and the first response message includes a Create Session Response message including an Activate EPS Bearer Context Request message.

In various embodiments, the first apparatus includes an MME, the first network entity includes a RAN node associated with the UAV, and the second network entity includes a HSS. In some embodiments, the aerial subscription information includes a value indicating whether an UAS service is allowed or unallowed.

Disclosed herein is a first method for distributing aerial subscription information, in accordance with aspects of the present disclosure. The first method may be performed by a network entity, such as the MME 131, the MME 305, and/or the network apparatus 800, as described above. The first method includes receiving, from a first network entity, a first request message for a service AA procedure and receiving, from a second network entity, aerial subscription information corresponding to an UAV associated with the first request message. The first method includes transmitting, to a third network entity, a second request message for the service AA procedure and receiving, from the third network entity, a first response message indicating a result of the service AA procedure. The first method includes transmitting a third request message including the aerial subscription information and the result of the service AA procedure.

In some embodiments, first request message includes an ePCO IE including: 1) a container identity; and 2) a Service-level AA container IE including A) a CAA-level UAV ID and B) at least one or more of: i) a USS address; ii) a UUAA aviation payload; or iii) a combination thereof. In certain embodiments, the container identity in the ePCO IE indicates that the first request message is for the service AA procedure.

In some embodiments, the first request message includes an APN associated with establishing a default bearer for UAS services. In certain embodiments, the APN indicates that the first request message is for the service AA procedure.

In some embodiments, the first request message includes an Attach Request message, the service AA procedure includes an UUAA procedure, and the third request message includes an Initial Context Setup Request message including an attach accept message.

In some embodiments, the first request message includes a PDN Connectivity Request message, and the service AA procedure includes an UUAA procedure, and the third request message includes a UE Context Modification Request message.

In some embodiments, the third network entity includes a SGW associated with a PGW, the second request message includes a Create Session Request message, and the first response message includes a Create Session Response message including an Activate EPS Bearer Context Request message.

In some embodiments, the first network entity includes a RAN node associated with the UAV and the second network entity includes a HSS. In some embodiments, the aerial subscription information includes a value indicating whether an UAS service is allowed or unallowed.

Disclosed herein is a second apparatus for distributing aerial subscription information, in accordance with aspects of the present disclosure. The second apparatus may be implemented by a network entity, such as a base station unit 121, the RAN node 210, the eNB 303, and/or the network apparatus 800, as described above. The second apparatus includes a processor coupled to a memory, the processor configured to cause the second apparatus to: A) receive, from a UAV, a first request message for a service AA procedure; B) transmit, to a first network entity, a second request message for the service AA procedure; C) receive, from the first network entity, a first response message including aerial subscription information corresponding to the UAV and a result of the service AA procedure; and D) transmit, to the UAV, a third request message to reconfigure a radio connection.

In some embodiments, the instructions are executable by the processor to cause the second apparatus to: A) determine a lost connection to the UAV; and B) forward a UE context including the aerial subscription information to a RAN node. In some embodiments, the second apparatus includes a RAN node and the first network entity includes a MME. In some embodiments, the aerial subscription information comprises a value indicating whether an UAS service is allowed or unallowed.

In some embodiments, the instructions are executable by the processor to cause the second apparatus to enable one or more features based at least in part on the result of the service AA procedure. In certain embodiments, the one or more features include: A) an aerial height including a lower threshold; B) an aerial height including an upper threshold; C) location information including a horizontal velocity; D) location information including a vertical velocity; E) flight path information; F) an open loop power control parameter to calculate a pathloss compensation factor; G) an interference detection based on UAV reporting measurements; or H) a combination thereof.

In some embodiments, first request message and the second request message include an ePCO IE including: 1) a container identity; and 2) a Service-level AA container IE including A) a CAA-level UAV ID and B) at least one or more of: i) a USS address; ii) a UUAA aviation payload; or iii) a combination thereof.

In certain embodiments, the container identity in the ePCO IE indicates that the first request message is for the service AA procedure. In certain embodiments, the indication that the second request message is for a service AA procedure includes the container identity in the ePCO IE indicates that the second request message is for the service AA procedure.

In some embodiments, the first request message and the second request message include an APN associated with establishing a default bearer for UAS services. In certain embodiments, the APN indicates that the first request message is for the service AA procedure. In certain embodiments, the indication that the second request message is for a service AA procedure includes the APN indicates that the second request message is for the service AA procedure.

In some embodiments, the first request message and the second request message include an Attach Request message, the service AA procedure includes a UUAA procedure, and the first response message includes an Initial Context Setup Request message including an attach accept message.

In some embodiments, the first request message and the second request message include a PDN Connectivity Request message, the service AA procedure includes an UUAA procedure, and the first response message includes a UE Context Modification Request message.

Disclosed herein is a second method for distributing aerial subscription information, in accordance with aspects of the present disclosure. The second method may be performed by a network entity, such as a base station unit 121, the RAN node 210, the eNB 303, and/or the network apparatus 800, as described above. The second method includes receiving, from a UAV, a first request message for a service AA procedure and transmitting, to a first network entity, a second request message for the service AA procedure. The second method includes receiving, from the first network entity, a first response message including aerial subscription information corresponding to the UAV and a result of the service AA procedure and transmitting, to the UAV, a third request message to reconfigure a radio connection.

In some embodiments, the second method further includes determining a lost connection to the UAV and forwarding a UE context including the aerial subscription information to a RAN node. In some embodiments, the first network entity includes a MME. In some embodiments, the aerial subscription information comprises a value indicating whether an UAS service is allowed or unallowed.

In some embodiments, the second method further includes enabling one or more features based at least in part on the result of the service AA procedure. In certain embodiments, the one or more features include: A) an aerial height including a lower threshold; B) an aerial height including an upper threshold; C) location information including a horizontal velocity; D) location information including a vertical velocity; E) flight path information; F) an open loop power control parameter to calculate a pathloss compensation factor; G) an interference detection based on UAV reporting measurements; or H) a combination thereof.

In some embodiments, first request message and the second request message include an ePCO IE including: 1) a container identity; and 2) a Service-level AA container IE including A) a CAA-level UAV ID and B) at least one or more of: i) a USS address; ii) a UUAA aviation payload; or iii) a combination thereof.

In certain embodiments, the container identity in the ePCO IE indicates that the first request message is for the service AA procedure. In certain embodiments, the container identity in the ePCO IE indicates that the second request message is for the service AA procedure.

In some embodiments, the first request message and the second request message include an APN associated with establishing a default bearer for UAS services. In certain embodiments, the APN indicates that the first request message is for the service AA procedure. In certain embodiments, the APN indicates that the second request message is for the service AA procedure.

In some embodiments, the first request message and the second request message include an Attach Request message, the service AA procedure includes an UUAA procedure, and the first response message includes an Initial Context Setup Request message including an attach accept message.

In some embodiments, the first request message and the second request message include a PDN Connectivity Request message, the service AA procedure includes an UUAA procedure, and the first response message includes a UE Context Modification Request message.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a RAM, a read-only memory (“ROM”), an erasable programmable read-only memory (“EPROM”), an electronically erasable programmable read-only memory (“EEPROM”), a Flash memory, a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), WLAN, or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “at least one of A, B and C” includes only A, only B, only C, a combination of A and B, a combination of B and C, a combination of A and C or a combination of A, B and C. As used herein, “a member selected from the group consisting of A, B, and C,” includes one and only one of A, B, or C, and excludes combinations of A, B, and C. As used herein, “a member selected from the group consisting of A, B, and C and combinations thereof” includes only A, only B, only C, a combination of A and B, a combination of B and C, a combination of A and C or a combination of A, B and C.

Aspects of the embodiments are described above with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

1. An apparatus comprising:
at least one memory; and
at least one processor coupled with the at least one memory and configured to cause the RAN apparatus to:
receive, from a first network entity, a first request message for a service authorization and authentication (“AA”) procedure;
receive, from a second network entity, aerial subscription information corresponding to an uncrewed aerial vehicle (“UAV”) associated with the first request message;
transmit, to a third network entity, a second request message for the service AA procedure;
receive, from the third network entity, a first response message indicating a result of the service AA procedure; and
transmit a third request message comprising the aerial subscription information and the result of the service AA procedure.

2. The apparatus of claim 1, wherein the first request message comprises an extended protocol configuration options (“ePCO”) information element (“IE”), wherein the ePCO IE comprises a container identity and a Service-level AA container IE, and wherein the Service-level AA container comprises a Civil Aviation Authority (“CAA”)-level UAV identifier (“ID”) and an Uncrewed aerial system Service Supplier (“USS”) address, an Uncrewed Aerial System Service Supplier/UAV Authorization and Authentication (“UUAA”) aviation payload, or both.

3. The apparatus of claim 2, wherein the container identity in the ePCO IE indicates that the first request message is for the service AA procedure.

4. The apparatus of claim 1, wherein the first request message comprises an access point name (“APN”) associated with establishing a default bearer for Uncrewed Aerial System (“UAS”) services.

5. The apparatus of claim 4, wherein the APN indicates that the first request message is for the service AA procedure.

6. The apparatus of claim 1, wherein the first request message comprises an Attach Request message, wherein the service AA procedure comprises an Uncrewed Aerial System Service Supplier/UAV Authorization and Authentication (“UUAA”) procedure, and wherein the third request message comprises an Initial Context Setup Request message comprising an attach accept message.

7. The apparatus of claim 1, wherein the first request message comprises a Packet Data Network (“PDN”) Connectivity Request message, wherein the service AA procedure comprises an Uncrewed Aerial System Service Supplier/UAV Authorization and Authentication (“UUAA”) procedure, and wherein the third request message comprises a User Equipment (“UE”) Context Modification Request message.

8. The apparatus of claim 1, wherein the third network entity comprises a serving gateway (“SGW”) associated with a packet data network (“PDN”) gateway (“PGW”), wherein the second request message comprises a Create Session Request message, and wherein the first response message comprises a Create Session Response message comprising an Activate Evolved Packet System (“EPS”) Bearer Context Request message.

9. The apparatus of claim 1, wherein the apparatus comprises a mobility management entity (“MME”), wherein the first network entity comprises a radio access network (“RAN”) node associated with the UAV, and wherein the second network entity comprises a Home Subscriber Server (“HSS”).

10. The apparatus of claim 1, wherein the aerial subscription information comprises a value indicating whether an uncrewed aerial system (“UAS”) service is allowed or unallowed.

11. A method at a mobility management entity, the method comprising:
receiving, from a first network entity, a first request message for a service authorization and authentication (“AA”) procedure;
receiving, from a second network entity, aerial subscription information corresponding to an uncrewed aerial vehicle (“UAV”) associated with the first request message;
transmitting, to a third network entity, a second request message for the service AA procedure;
receiving, from the third network entity, a first response message indicating a result of the service AA procedure; and
transmitting a third request message comprising the aerial subscription information and the result of the service AA procedure.

12. A Radio Access Network (“RAN”) apparatus comprising:
at least one memory; and
at least one processor coupled with the at least one memory and configured to cause the RAN apparatus to:
receive, from an uncrewed aerial vehicle (“UAV”), a first request message for a service authorization and authentication (“AA”) procedure;
transmit, to a first network entity, a second request message for the service AA procedure;
receive, from the first network entity, a first response message comprising aerial subscription information corresponding to the UAV and a result of the service AA procedure; and
transmit, to the UAV, a third request message to reconfigure a radio connection.

13. The RAN apparatus of claim 12, wherein the at least one processor is configured to cause the RAN apparatus to:
determine a lost connection to the UAV; and
forward a User Equipment (“UE”) context comprising the aerial subscription information to a RAN node,
wherein the aerial subscription information comprises a value indicating whether an uncrewed aerial system (“UAS”) service is allowed or unallowed.

14. The RAN apparatus of claim 12, wherein the at least one processor is configured to cause the RAN apparatus to enable one or more features based at least in part on the result of the service AA procedure.

15. The RAN apparatus of claim 14, wherein the one or more features comprise:
an aerial height comprising a lower threshold;
an aerial height comprising an upper threshold;
location information comprising a horizontal velocity;
location information comprising a vertical velocity;
flight path information;
an open loop power control parameter to calculate a pathloss compensation factor;
an interference detection based on UAV reporting measurements;
or a combination thereof.

16. The RAN apparatus of claim 12, wherein the first request message comprises an extended protocol configuration options (“ePCO”) information element (“IE”), wherein the ePCO IE comprises a container identity and a Service-level AA container IE, and wherein the Service-level AA container comprises a Civil Aviation Authority (“CAA”)-level UAV identifier (“ID”) and an Uncrewed aerial system Service Supplier (“USS”) address, an Uncrewed Aerial System Service Supplier/UAV Authorization and Authentication (“UUAA”) aviation payload, or both.

17. The RAN apparatus of claim 12, wherein the first request message comprises an access point name (“APN”) associated with establishing a default bearer for Uncrewed Aerial System (“UAS”) services, and wherein the APN indicates that the first request message is for the service AA procedure.

18. The RAN apparatus of claim 12, wherein the first request message comprises an Attach Request message, wherein the service AA procedure comprises an Uncrewed Aerial System Service Supplier/UAV Authorization and Authentication (“UUAA”) procedure, and wherein the third request message comprises an Initial Context Setup Request message comprising an attach accept message.

19. The RAN apparatus of claim 12, wherein the first request message comprises a Packet Data Network (“PDN”) Connectivity Request message, wherein the service AA procedure comprises an Uncrewed Aerial System Service Supplier/UAV Authorization and Authentication (“UUAA”) procedure, and wherein the third request message comprises a User Equipment (“UE”) Context Modification Request message.

20. The RAN apparatus of claim 12, wherein the first network entity comprises a mobility management entity (“MME”), wherein the second request message comprises a Create Session Request message, wherein the first response message comprises a Create Session Response message comprising an Activate Evolved Packet System (“EPS”) Bearer Context Request message, and wherein the aerial subscription information comprises a value indicating whether an uncrewed aerial system (“UAS”) service is allowed or unallowed.
